(19) United States
(12) Patent Application Publication
(10) Pub. No.: US 2017/0313051 A1
(43) Pub. Date: Nov. 2, 2017

(54) PRINTING APPARATUS AND PRINTING METHOD

(71) Applicant: FUJIFILM CORPORATION, Tokyo (JP)

(72) Inventor: Kenichi KODAMA, Kanagawa (JP)

(73) Assignee: FUJIFILM CORPORATION, Tokyo (JP)

(21) Appl. No.: 15/654,746

(22) Filed: Jul. 20, 2017

Related U.S. Application Data
(63) Continuation of application No. PCT/JP2016/050264, filed on Jan. 6, 2016.

(30) Foreign Application Priority Data
Feb. 19, 2015 (JP) 2015-031020

(51) Int. Cl. B41C 1/02; B41N 1/12; B41N 1/06; B41F 3/38; B41M 1/06; B41F 13/18; B41F 17/24

(52) U.S. Cl. CPC B41C 1/025; B41N 1/06; B41N 1/12; B41F 3/38; B41F 13/18; B41F 17/24; G06F 2203/04103; B41M 1/06

(57) ABSTRACT

A printing apparatus and a printing method for applying ink to a surface of a printing plate in a predetermined pattern and then transfer the ink applied in the shape of the pattern to a substrate. A scale is formed on the surface of the printing plate; the printing apparatus includes a plate cylinder on which the printing plate is provided, an image recording section that applies the ink to the surface of the printing plate in the predetermined pattern by an ink jet method, a reading unit that reads the scale and obtains position information data of the scale, a signal generation part that generates a signal based on the position information data obtained by the reading unit, and an adjustment part that adjusts an ejection timing of the ink in the image recording section on the basis of the signal obtained by the signal generation part.

### CROSS-REFERENCE TO RELATED APPLICATIONS

This application is a Continuation of PCT International Application No. PCT/JP2016/050264 filed on Jan. 6, 2016, which claims priority under 35 U.S.C. §119(a) to Japanese Patent Application No. 2015-031020 filed on Feb. 19, 2015. The above application is hereby expressly incorporated by reference, in its entirety, into the present application.

### BACKGROUND OF THE INVENTION

### 1. Field of the Invention

The present invention relates to a printing apparatus and a printing method that provide a scale on a printing plate, read position information of the scale, and perform inking on the printing plate with high accuracy by controlling an ejection timing, and more particularly, to a printing apparatus and a printing method that can be used to form a gate electrode, a source electrode, a drain electrode, wires, and the like of a thin-film transistor used in electronic paper and the like.

### 2. Description of the Related Art

In recent years, gate electrodes, source electrodes, drain electrodes, and metal wires of thin-film transistors and fine patterns, such as electrical wiring patterns, have been formed on a glass substrate, a resin substrate, or the like by using a printing method. A substrate on which fine patterns are formed with liquid containing conductive particles, such as metal, by a printing method is used in thin display devices, such as electronic paper and a liquid crystal display, a portable communication device, and the like.

There is an inking technique that improves scumming caused by doctoring and the durability of a plate by making the inking of intaglio printing apply the necessary amount of ink to a necessary position with an ink jet method to make doctoring unnecessary. There is a pattern printing apparatus disclosed in, for example, JP2005-81726A as a specific example of the inking technique. In the pattern printing apparatus disclosed in JP2005-81726A, a thin resin layer is provided on a flexible metal flat-plate-shaped intaglio plate and an ink repellent pattern is formed thereon to form recessed portions. Ink is sprayed and supplied to the recessed portions from below by the ink jet of ink supply means. After the ink is supplied, a solvent is vaporized from the ink, which is present in the recessed portions, by ink drying means so that the ink is dried without losing viscosity. A printing target and the flexible metal flat-plate-shaped intaglio plate are positioned, and the flexible metal flat-plate-shaped intaglio plate is pressed by a press/release cylinder of ink transfer means while the printing target and the flexible metal flat-plate-shaped intaglio plate are made to roll. As a result, the ink, which is present in the recessed portions, is transferred to the printing target. After the ink is transferred, the flexible metal flat-plate-shaped intaglio plate is released while being bent.

Substrates on which fine patterns, which are used for the thin display devices, such as electronic paper and a liquid crystal display, the portable communication device, and the like having been described above, are formed by, for example, printing apparatuses disclosed in JP2007-160538A and JP4511974B, which are to be described below, other than the above-mentioned pattern printing apparatus disclosed in JP2005-81726A.

The printing apparatus disclosed in JP2007-160538A includes a plate cylinder on which a plate corresponding to a printing pattern is provided, a blanket cylinder on which a blanket is wound and which receives the printing pattern from the plate and transfers the printing pattern to a glass substrate, a scale that is used to obtain the peripheral speed of the blanket, a CCD (charge-coupled device) camera that reads the scale, and a control section that controls a motor driving the blanket cylinder on the basis of the output of the CCD camera.

The printing apparatus disclosed in JP4511974B includes a motor that rotationally drives a cylindrical plate cylinder on which a scale representing information about an angular position at the time of writing of a written pattern written at each angular position is written, a CCD camera that reads the scale, and a control section that adjusts the feed distance of the cylindrical plate cylinder on the basis of the number of detected pulses obtained by the CCD camera.

### SUMMARY OF THE INVENTION

The apparatus, which presses the flexible metal flat-plate-shaped intaglio plate to transfer ink, which is present in the recessed portions, to the printing target, is disclosed in JP2005-81726A as described above, but does not perform the correction and the like of an ink pattern corresponding to the mounting of the plate in, for example, a case in which the mounting accuracy of the plate is low. There is a problem that printing accuracy deteriorates when an error occurs during the formation of a pattern.

In the printing apparatus disclosed in JP2007-160538A, the scale is formed after the mounting of the blanket on the blanket cylinder or the blanket is attached after the formation of the scale on the blanket cylinder in advance. Further, in the printing machine disclosed in JP4511974B, a printing pattern and the scale are directly formed on the plate cylinder.

However, since an object of JP2007-160538A is to accurately control the peripheral speed of the blanket cylinder and an object of JP4511974B is to cancel an error at the time of the making of the plate, JP2007-160538A and JP4511974B do not use the above-mentioned inking technique but use gravure printing. Since a case in which the mounting accuracy of the plate is low is not considered in JP2007-160538A and JP4511974B, the correction and the like of an ink pattern corresponding to the mounting of the plate are not performed in JP2007-160538A and JP4511974B in a case in which the mounting accuracy of the plate is low.

An object of the invention is to solve the problems based on the above-mentioned related art and is to provide a printing apparatus and a printing method of which printing accuracy is improved even in a case in which the mounting accuracy of a printing plate is low.

In order to achieve the object, the invention provides a printing apparatus that applies ink to a surface of a printing plate in the shape of a predetermined pattern and then transfers the ink applied in the shape of the pattern to a substrate. A scale is formed on the surface of the printing plate. The apparatus comprises a plate cylinder on which the printing plate is provided, an image recording section that applies the ink to the surface of the printing plate in the shape of the predetermined pattern by an ink jet method, a reading unit that reads the scale and obtains position information data of the scale, a signal generation part that generates a signal based on the position information data obtained by the reading unit, and an adjustment part that adjusts an ejection timing of the ink in the image recording section on the basis of the signal obtained by the signal generation part.

It is preferable that the scale is formed of recessed portions and protruding portions formed on the surface of the printing plate and the ink is applied to the recessed portions or the protruding portions by the image recording section.

It is preferable that the image recording section includes an ink jet head ejecting the ink to the surface of the printing plate and a carriage supporting the ink jet head and moving the ink jet head in a direction parallel to a rotating shaft of the plate cylinder and the reading unit is provided on the carriage.

It is preferable that the printing apparatus further comprises a mounting-position-information acquisition unit acquiring mounting information of the printing plate provided on the plate cylinder and a correction part correcting ejection pattern data of the ink ejected to the surface of the printing plate and creating corrected pattern data on the basis of the mounting information of the printing plate obtained by the mounting-position-information acquisition unit and the image recording section applies the ink to the surface of the printing plate on the basis of the corrected pattern data.

For example, the printing apparatus further comprises a mounting-position-information acquisition unit that acquires mounting information of the printing plate provided on the plate cylinder and a rotating unit that rotates the ink jet head on the basis of the mounting information of the printing plate obtained by the mounting-position-information acquisition unit, and the ink jet head is rotated by the rotating unit and is moved in a direction parallel to the rotating shaft by the carriage on the basis of the mounting information of the printing plate.

For example, the printing plate is an intaglio plate, and the ink is applied to the recessed portions formed in the shape of the pattern.

The invention provides a printing method that applies ink to a surface of a printing plate provided on a plate cylinder in the shape of a predetermined pattern and then transfers the ink applied in the shape of the pattern to a substrate. A scale is formed on the surface of the printing plate. The method comprises an acquisition step of reading the scale and obtaining position information data of the scale, an adjustment step of generating a signal based on the position information data and adjusting an ejection timing of the ink, which is obtained when the ink is applied in the shape of the predetermined pattern by an ink jet method, on the basis of the signal, and an application step of applying ink to the surface of the printing plate at the ejection timing that is adjusted by the adjustment step.

It is preferable that the adjustment step comprises a step of acquiring mounting information of the printing plate provided on the plate cylinder and a step of correcting ejection pattern data of the ink ejected to the surface of the printing plate and creating corrected pattern data on the basis of the mounting information of the printing plate and the application step comprises a step of applying the ink to the surface of the printing plate on the basis of the corrected pattern data.

Further, it is preferable that the adjustment step comprises a step of acquiring the mounting information of the printing plate provided on the plate cylinder and a step of rotating the ink jet head and moving the ink jet head in a direction perpendicular to a feed direction of the printing plate on the basis of the mounting information of the printing plate.

According to the invention, it is possible to provide a printing apparatus and a printing method of which printing accuracy is improved even in a case in which the mounting accuracy of a printing plate is low.

### BRIEF DESCRIPTION OF THE DRAWINGS

FIG. 1 is a schematic diagram showing a printing apparatus of an embodiment of the invention.

FIG. 2 is a schematic diagram showing an image recording section of the printing apparatus of the embodiment of the invention.

FIG. 3 is a plan view showing the arrangement of nozzles of an ink jet head.

FIG. 4 is a plan view showing another example of the arrangement of nozzles of the ink jet head.

FIG. 5 is a schematic diagram showing an ink supply mechanism of the printing apparatus of the embodiment of the invention.

FIG. 6 is a schematic diagram showing an example of a printing plate that is used in the printing apparatus of the embodiment of the invention.

FIG. 7 is a schematic cross-sectional view showing the example of the printing plate that is used in the printing apparatus of the embodiment of the invention.

FIG. 8 is a schematic cross-sectional view showing the structure of a scale.

FIG. 9 is a schematic diagram showing another example of the scale.

FIG. 10 is a schematic diagram showing an example of a maintenance section of the printing apparatus of the embodiment of the invention.

FIG. 11 is a schematic diagram showing an ejection observation unit and a nozzle observation unit of the maintenance section of the printing apparatus of the embodiment of the invention.

FIG. 12 is a schematic diagram showing an example of a thin-film transistor that is formed by the printing apparatus of the embodiment of the invention.

FIG. 13 is a schematic diagram illustrating a first example of the inclination correction of the printing apparatus of the embodiment of the invention.

FIG. 14 is a schematic diagram illustrating a second example of the inclination correction of the printing apparatus of the embodiment of the invention.

FIG. 15 is an enlarged schematic diagram of main parts of FIG. 14.

FIG. 16 is a schematic diagram showing an example of a specific example of the inclination correction of the printing apparatus of the embodiment of the invention.

FIG. 17 is a schematic diagram showing another example of a specific example of the inclination correction of the printing apparatus of the embodiment of the invention.

FIG. 18 is a schematic cross-sectional view showing a step of forming a wiring pattern, which is formed by the printing apparatus of the embodiment of the invention, in the order of steps.

FIG. 19 is a schematic cross-sectional view showing the step of forming the wiring pattern, which is formed by the printing apparatus of the embodiment of the invention, in the order of steps.

FIG. 20 is a schematic cross-sectional view showing the step of forming the wiring pattern, which is formed by the printing apparatus of the embodiment of the invention, in the order of steps.

FIG. 21 is a schematic cross-sectional view showing a first example of the printing plate from which ink is not yet transferred.

FIG. 22 is a schematic cross-sectional view showing a pattern that has been transferred to the printing plate.

FIG. 23 is a schematic cross-sectional view showing a second example of the printing plate from which ink is not yet transferred.

FIG. 24 is a schematic cross-sectional view showing a pattern that has been transferred to the printing plate.

FIG. 25 is a schematic cross-sectional view showing a third example of the printing plate from which ink is not yet transferred.

FIG. 26 is a schematic cross-sectional view showing an example of a pattern that has been transferred to the printing plate.

FIG. 27 is a schematic cross-sectional view showing another example of the pattern that has been transferred to the printing plate.

FIG. 28 is a schematic diagram showing a state in which ink has been applied to a pattern.

FIG. 29 is a schematic diagram showing a state in which first ink has been applied to the pattern.

FIG. 30 is a schematic diagram showing a state in which second ink has been applied to the pattern.

FIG. 31 is a schematic diagram showing a state in which first ink has been applied to a pattern.

FIG. 32 is a schematic diagram showing a state in which second ink has been applied to the pattern.

FIG. 33 is a schematic diagram illustrating a printing method of an embodiment of the invention.

FIG. 34 is a flow chart illustrating the printing method of the embodiment of the invention.

### DESCRIPTION OF THE PREFERRED EMBODIMENTS

A printing apparatus and a printing method of the invention will be described in detail below on the basis of preferred embodiments shown in the accompanying drawings. The invention is not limited to the printing apparatus and the printing method of embodiments to be described below.

“˜” representing the range of a numerical value to be described below includes numerical values that are written on both sides of “˜”. For example, a fact that ε is in the range of a numerical value β1˜a numerical value β2 means that the range of ε is a range including the numerical value β1 and the numerical value β2, and is expressed as “β1≦εβ2” by mathematical symbols.

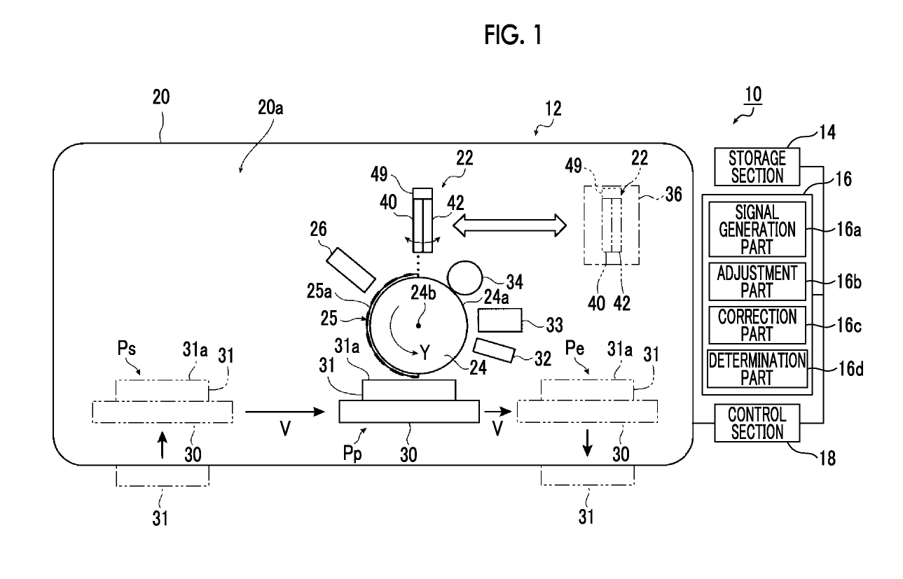

FIG. 1 is a schematic diagram showing a printing apparatus of an embodiment of the invention.

As shown in FIG. 1, the printing apparatus 10 includes a printing apparatus body 12, a storage section 14, an adjustment unit 16, and a control section 18.

The printing apparatus body 12 is to form a predetermined pattern on a substrate 31 by a printing method. The printing apparatus body 12 will be described in detail below.

The storage section 14 is to store various kinds of information used in the printing apparatus 10. The pattern data of a pattern to be printed is stored in the storage section 14, but the pattern data is appropriately input from the outside.

Further, although described in detail below, ejection pattern data and ejection timing data of ink that is ejected from an ink jet head 40, corrected pattern data that is obtained from the correction of the ejection pattern data of the ink performed in accordance with the mounting state of a printing plate 25, and corrected ejection timing data that is obtained from the correction of the ejection timing data performed in accordance with to the mounting state of the printing plate 25 are also stored in the storage section 14.

The ejection pattern data of the ink is data that represents an ejection pattern when the ink is applied to a pattern area of the printing plate 25 by the ink jet head 40.

The ejection timing data is data that represents a timing at which ink is ejected to the pattern area of the printing plate 25 when the ink is applied to the pattern area of the printing plate 25 by the ink jet head 40.

Information about a reference shape, which serves as a reference of a surface 25a of the printing plate 25 on which ink has been applied to a specific pattern, is stored in the storage section 14.

The information about the reference shape is, for example, image data representing an ideal state when ink is applied to the pattern area of the printing plate 25. Further, in a case in which ink is applied to the pattern area of the printing plate 25 multiple times, the information about the reference shape is image data representing an ideal state of each of the multiple times. For example, in a case in which ink is ejected to the pattern area by an ink jet method, dots are formed, and ink is applied to the pattern area, image data, which represents the ideal arrangement of dots formed by the ejection of ink of each time, is the above-mentioned information about the reference shape.

Although described in detail below, information, such as the pitch of each of scales 27 formed on the printing plate 25, is stored in the storage section 14. When the scales 27 are read by reading units 47, information, which is stored in the storage section 14, about the scales 27, which are formed on the printing plate 25, is used.

Further, image data, which represents the ideal state of the surface 25a of the printing plate 25 from which ink has been transferred, is also included in the information about the reference shape.

A method of inputting the information about the reference shape and the pattern data to the storage section 14 is not particularly limited. Various interfaces are provided in the storage section 14, and the information about the reference shape and the pattern data can be input to the storage section 14 through a storage medium and a wired or wireless network.

The adjustment unit 16 is to perform various kinds of adjustment, such as the correction of an ejection timing of ink and image data, in order to perform inking on the printing plate 25 with high accuracy.

The adjustment unit 16 includes a signal generation part 16a, an adjustment part 16b, a correction part 16c, and a determination part 16d.

The signal generation part 16a is to generate signals based on position information data that is obtained by the reading units 47. The reading units 47 will be described below.

The adjustment part 16b is to adjust the ejection timing of ink in the ink jet head 40 of an image recording section 22 on the basis of the signal obtained by the signal generation part 16a. The signal obtained by the signal generation part 16a is also referred to as an encoder signal. Corrected ejection timing data of the ejection timing of ink in the ink jet head 40 is created by the adjustment part 16b. The corrected ejection timing data is stored in the storage section 14.

Further, the adjustment part 16b creates the corrected pattern data by correcting the ejection pattern data of the ink to be ejected to the surface 25a or creates the corrected ejection timing data by correcting the ejection timing data, on the basis of mounting information of the printing plate 25 on a plate cylinder 24 that is obtained by an alignment camera 42 to be described in detail below.

For example, the creation of the corrected ejection timing data, which is performed by the adjustment part 16b, is performed when the determination part 16d compares an inclination angle α of the printing plate 25 with an allowable range on the basis of the mounting information of the printing plate 25 and determines that the inclination angle α is out of the allowable range.

In a case in which the printing plate 25 is disposed so as to be inclined at an angle α with respect to an ideally disposed printing plate 25i on the basis of the mounting information of the printing plate 25 obtained by the alignment camera 42, the correction part 16c creates corrected pattern data by multiplying the ejection pattern data of the ink by cos α. The corrected pattern data is stored in the storage section 14.

For example, the creation of the corrected pattern data, which is performed by the correction part 16c, is performed when the determination part 16d compares the inclination angle α of the printing plate 25 with an allowable range on the basis of the mounting information of the printing plate 25 and determines that the inclination angle α is out of the allowable range.

Further, the correction part 16c calculates the rotation angle of the ink jet head 40, which is to be rotated, on the basis of the mounting position information of the printing plate 25, which is obtained by a plate surface observation unit 26, and stores the calculated rotation angle in the storage section 14. The ink jet head 40 is rotated on the basis of the rotation angle and is allowed to eject ink by the control section 18.

The determination part 16d is used to acquire the mounting information of the printing plate 25 that is provided on the plate cylinder 24. The determination part 16d is to specify the positions of alignment marks A to D by using the position information of alignment marks obtained by the alignment camera 42 to be described below. Accordingly, the mounting information of the printing plate 25, which is provided on the plate cylinder 24, can be acquired.

The determination part 16d is to compare the inclination angle α of the printing plate 25 with an allowable range on the basis of the mounting position information of the printing plate 25 and is to determine whether or not the inclination angle α is out of the allowable range. The determination part 16d is to output determination information, which corresponds to determination results, to the control section 18. The inclination angle α of the printing plate 25 will be described below.

The determination part 16d compares the information, which is obtained by the plate surface observation unit 26 of the printing apparatus body 12 to be described below, about the surface 25a of the printing plate 25 on which ink has been applied to a specific pattern with the information, which is stored in the storage section 14, about a reference shape that serves as a reference of the surface 25a of the printing plate 25 on which ink has been applied to a specific pattern; and determines whether or not the ink is present in a predetermined range of the reference shape. The determination part 16d is to output determination information, which corresponds to determination results, to the control section 18.

Further, in a case in which ink deviates from the predetermined range, the determination part 16d is to also specify a position at which ink deviates, and the like. For example, in a case in which ink is applied to a pattern area so as to protrude from the pattern area, the determination part 16d specifies a portion at which the ink protrudes. Furthermore, in a case in which ink is applied to a pattern area by an ink jet method, the determination part 16d can specify deviations in the positions of dots formed by ink, areas in which the dots is not present, and the like. Accordingly, the control section 18 adjusts the amount of ink, which is to be ejected, and the like in accordance with a specified position as described below.

The control section 18 is connected to the printing apparatus body 12, the storage section 14, and the adjustment unit 16, and is to control the respective elements of the printing apparatus body 12, the storage section 14, and the adjustment unit 16.

Further, the control section 18 controls the respective sections in accordance with the respective results that are obtained by the adjustment unit 16. For example, in a case in which the corrected pattern data of the ejection pattern data is created by the adjustment unit 16, ink is ejected from the ink jet head 40 on the basis of the corrected pattern data by the control section 18.

The corrected ejection timing data of the ejection timing of ink in the ink jet head 40 is created by the adjustment part 16b.

Next, the printing apparatus body 12 will be described.

The respective elements of the printing apparatus body 12 are provided on the inside 20a of a casing 20 so that printing is performed in a clean atmosphere. Filters (not shown) and air-conditioning facilities (not shown) are provided so that predetermined cleanliness is made on the inside 20a of the casing 20.

The printing apparatus body 12 includes an image recording section 22, the plate cylinder 24, the plate surface observation unit 26, a stage 30, a drying unit 32, an ionizer 33, a cleaning unit 34, and a maintenance section 36.

The image recording section 22, the plate surface observation unit 26, the drying unit 32, the ionizer 33, and the cleaning unit 34 are provided so as to surround a surface 24a of the plate cylinder 24. The cleaning unit 34 is provided so as to be in contact with the surface 24a of the plate cylinder 24.

A substrate 31 is disposed on the stage 30, and the stage 30 is disposed so that the printing plate 25 and a surface 31a of the substrate 31 come into contact with each other when the plate cylinder 24 is rotated in a state in which the stage 30 is positioned at a printing position Pp below the plate cylinder 24. Accordingly, ink, which is applied to the surface 25a of the printing plate 25 in the shape of a predetermined pattern, is transferred to the surface 31a of the substrate 31.

The ink is fired on the substrate 31, which has been subjected to printing, by, for example, heat, light, or the like according to the characteristics of the ink. Publicly known means used in the firing of ink, which is performed using heat or light, can be appropriately used. The firing of ink on the substrate 31 may be performed on the inside 20a of the casing 20 and may be performed on the outside of the casing 20.

Ink has been applied to the pattern area of the printing plate 25 provided on the plate cylinder 24 in the printing apparatus 10, but the application of ink may be completed at one time and ink may be applied multiple times. In a case in which ink is applied multiple times, the plate cylinder 24 is rotated by the number of times of the application of ink. For example, in a case in which ink is applied four times, the plate cylinder 24 is rotated four times. The application of ink is referred to as “inking”. Further, the application of ink of one time of the multiple times is also referred to as “scanning”.

The respective elements of the printing apparatus body 12 will be described below.

The image recording section 22 is to apply ink to the surface 25a of the printing plate 25, and ink is applied to the surface 25a in a predetermined pattern by the image recording section 22. An image recording method of the image recording section 22 is not particularly limited. For example, an ink jet method is used as the image recording method.

The plate cylinder 24 is rotatable about a rotating shaft 24b in a Y direction. Further, the plate cylinder 24 is to transfer the ink of the surface 25a of the printing plate 25, which is applied in the shape of a predetermined pattern, to the surface 31a of the substrate 31 by being rotated in a state in which the plate cylinder 24 holds the printing plate 25.

For example, a motor (not shown), which rotates the plate cylinder 24, is provided on the rotating shaft 24b through a gear (not shown) and the like. A direct-drive motor, which does not need a gear, can be provided. The motor is controlled by the control section 18. Further, a rotary encoder (not shown), which detects rotation and a rotation angle, is provided on the rotating shaft 24b. Since the rotary encoder is connected to the control section 18, the rotation angle of the plate cylinder 24 is detected by the control section 18.

The substrate 31 to which ink is to be transferred is not particularly limited. Film substrates, such as polyethylene naphthalate (PEN), polyethylene terephthalate (PET), and polycarbonate (PC); a glass epoxy substrate; a ceramic substrate; and a glass substrate can be used as the substrate. In regard to a method of transferring ink, in the case of a rigid substrate, such as a glass substrate, it is possible to transfer ink to the surface 31a of the substrate 31 by fixing the substrate 31 to the stage 30 and making the substrate 31 come into close contact with the plate cylinder 24 as described above.

In a case in which a film is used as the printing plate 25, an impression cylinder may be used to fix the film to the impression cylinder and to make the film come into close contact with the plate cylinder 24 so that ink is transferred.

The plate surface observation unit 26 is disposed on the downstream side of the image recording section 22 in the Y direction of the plate cylinder 24. The plate surface observation unit 26 is to acquire information about the surface 25a of the printing plate 25 to which ink has been applied. Further, the plate surface observation unit 26 is to also acquire information about the surface 25a of the printing plate 25 from which ink has been transferred to the substrate 31.

As long as the plate surface observation unit 26 can acquire information about the surface 25a of the printing plate 25 obtained before and after the transfer of ink, the structure of the plate surface observation unit 26 is not particularly limited. Since the printing plate 25 often has a rectangular shape, it is preferable that a line sensor and a linear illumination are used as the plate surface observation unit 26. In this case, plate surface-imaging data is obtained as the information about the surface 25a. This plate surface-imaging data is compared with the information about the reference shape and is determined by the determination part 16d of the adjustment unit 16 as described above.

For example, a monochrome CMOS (complementary metal-oxide semiconductor) sensor or a monochrome CCD (charge-coupled device) sensor can be used as the line sensor. Since the shadows of structures as ejected ink droplets are observed, a color CMOS sensor or a color CCD sensor does not need to be used. Furthermore, lenses, various filters, and the like may be provided in front of the line sensor. For example, a unit in which LEDs (light-emitting diodes) are arranged linearly can be used as the linear illumination.

Since the plate surface observation unit 26 is connected to the control section 18, a timing at which the information about the surface 25a of the printing plate 25 is to be acquired by the plate surface observation unit 26 is controlled by the control section 18 and the acquired information about the surface 25a of the printing plate 25 is stored in the storage section 14.

In a case in which transparent ink, such as an insulator, is used as ink, it is difficult to identify the ink with the naked eye. However, it is possible to improve the identification of the ink, which is performed by the line sensor, through the installation of a light source and a polarization filter in front of the line sensor, illumination performed from two or more positions, or the like.

Further, since the acquisition of the information about the surface 25a of the printing plate 25 is performed at the time of each scanning, it is possible to detect a deviation in a landing position, a satellite, and the unevenness of the thickness of an ink film that is caused by a change in the number of droplets to be ejected. For example, when a relationship between the thickness of an ink film and optical characteristics is measured in advance and is stored in the storage section 14, the thickness of an ink film can be estimated through the comparison between the above-mentioned relationship and detected optical characteristics.

Further, in a case in which silver nano-ink is used as ink, silver gloss is expressed from the silver nano-ink during drying and a color or reflectivity of the silver nano-ink is changed. When an ink film is thin, the ink film is quickly dried. When an ink film is thick, the ink film is slowly dried. For this reason, when a relationship between the thickness of an ink film at a preset time until detection and the color of the ink film and a relationship between the thickness of an ink film and the reflectivity of the ink film are measured in advance, the thickness of the ink film can be estimated.

In the case of transparent ink, such as an insulator, the thickness of an ink film can be estimated from interference fringes. When a relationship between the thickness of an ink film and interference fringes is measured in advance, the thickness of an ink film can be estimated. In the case of crystalline ink, such as a semiconductor, a polarization filter is provided and the thickness of an ink film can also be estimated from the color of the ink film. Even in this case, the thickness of an ink film can be estimated when a relationship between the thickness of the ink film and the color of the ink film is measured in advance.

The stage 30 is a unit on which a substrate 31 is placed and which is moved in a transport direction V to transport the substrate 31 to a predetermined position. The stage 30 is provided with a transport mechanism (not shown). Since the transport mechanism is connected to the control section 18, the transport mechanism is controlled by the control section 18 and the stage 30 is moved in the transport direction V so that the position of the stage 30 is changed.

First, the stage 30 stands by at a starting position Ps where the substrate 31 transported from the outside of the casing 20 is placed on the stage 30. After that, the stage 30 is moved to a printing position Pp below the plate cylinder 24. Then, after printing, the stage 30 is moved to an end position Pe in a state in which the substrate 31 having been subjected to printing is placed on the stage 30. After that, the substrate 31 is taken out to the outside of the casing 20. The stage 30 is moved to the starting position Ps from the end position Pe, and stands by until a substrate 31 is carried in.

The drying unit 32 is to dry the ink of the surface 25a of the printing plate 25. As long as ink can be dried, a drying method is not particularly limited. Examples of the drying method include the blowing of hot air or cold air performed by a fan, heating performed by an infrared heater, the irradiation of a high-frequency wave, the irradiation of a microwave, and the like.

The drying unit 32 does not necessarily need to be provided in a case in which the ink of the surface 25a of the printing plate 25 can be dried by natural drying.

The ionizer 33 is to eliminate the electricity of the surface 25a of the printing plate 25. The static electricity of the surface 25a of the printing plate 25 is eliminated by the ionizer 33, so that the adhesion of foreign materials, such as dirt or dust, to the surface 25a of the printing plate 25 is suppressed. Further, in a case in which the surface 25a of the printing plate 25 is charged with electricity, ink may bend. However, since the bending of ink can be prevented, ink-jet ejection accuracy is improved.

A static electricity eliminator can be used as the ionizer 33. For example, a corona discharge-type static electricity eliminator and an ion generation-type static electricity eliminator can be used as the ionizer 33. Furthermore, the ionizer 33 has been provided on the downstream side of the drying unit 32 in the Y direction. However, as long as the ionizer 33 can remove the static electricity of the surface 25a of the printing plate 25 before recording is performed by the image recording section 22, the position of the ionizer 33 is not particularly limited.

The cleaning unit 34 is to remove ink adhering to the plate cylinder 24 and the printing plate 25. As long as the cleaning unit 34 can remove the ink adhering to the plate cylinder 24 and the printing plate 25, the structure of the cleaning unit 34 is not particularly limited. For example, the cleaning unit 34 is adapted to push a roller against the plate cylinder 24, to transfer ink to the roller, and to wipe off the transferred ink.

The maintenance section 36 checks whether or not the ejection characteristics of the image recording section 22 and the like exhibit predetermined performance. The maintenance section 36 is to wipe nozzles so that predetermined performance is exhibited. The maintenance section 36 is provided at a position away from the plate cylinder 24. The image recording section 22 is transported to the maintenance section 36 through, for example, a guide rail (not shown). The maintenance section 36 will be described in detail below.

The image recording section 22 will be described in detail below.

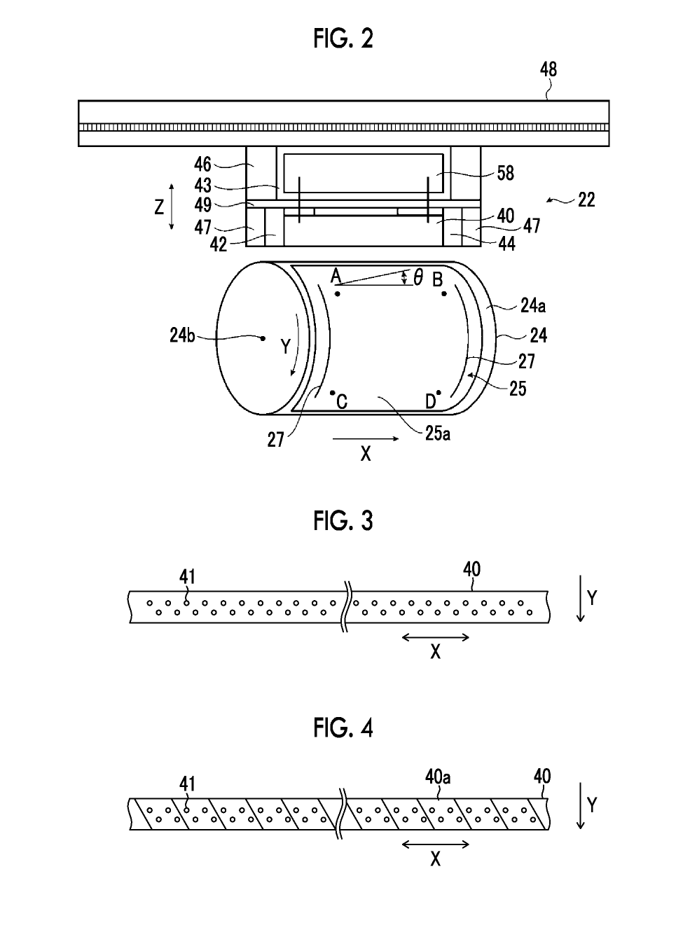

FIG. 2 is a schematic diagram showing the image recording section of the printing apparatus of the embodiment of the invention.

An example in which an ink jet method is used in the image recording section 22 will be described.

As shown in FIG. 2, the image recording section 22 includes the ink jet head 40, the alignment camera 42, a laser displacement meter 44, reading units 47, and a rotating unit 49; and the ink jet head 40, the alignment camera 42, and the laser displacement meter 44, the reading units 47, and the rotating unit 49 are provided on a carriage 46. Since the carriage 46 can be moved in a direction parallel to the rotating shaft 24b of the plate cylinder 24, that is, an X direction by a linear motor 48, the ink jet head 40 can be moved in the X direction by the carriage 46.

The ink jet head 40 is provided with an ejection control unit 43 that controls the ejection of ink. The ejection waveform of ink is adjusted by the ejection control unit 43. The ejection control unit 43 is connected to the control section 18. The ejection control unit 43 allows a user to adjust a discharge voltage or an ejection waveform through, for example, a user interface. Ink is ejected in a state in which the temperature of ink is adjusted as described below.

The alignment camera 42, the laser displacement meter 44, and the reading units 47 are also connected to the control section 18. Since the carriage 46 is provided with a drive unit (not shown) moving the carriage 46 in a Z direction and the drive unit is connected to the control section 18, the movement of the carriage 46 in the Z direction is controlled by the control section 18. Here, the Z direction is a direction perpendicular to the surface 24a of the plate cylinder 24.

The alignment camera 42 is to obtain the position information of alignment marks that is used to correct the ejection position of ink, the ejection timing of ink, and pattern data.

As long as the alignment camera 42 can detect the alignment marks A to D, the structure of the alignment camera 42 is not particularly limited.

The alignment marks A to D are imaged by the alignment camera 42, the imaging data of the alignment marks A to D are stored in the storage section 14, and the positions of the alignment marks A to D are specified by the determination part 16d. The alignment camera 42 and the determination part 16d function as a mounting-position-information acquisition unit that acquires the mounting information of the printing plate 25 provided on the plate cylinder 24.

Information about an ink ejection starting position (inking starting position) in the Y direction, the expansion/contraction of the printing plate in the X direction, and the inclination angle θ of the printing plate can be obtained from the position information of the alignment marks A and B. Information about an ink ejection starting position (inking starting position) in the X direction and the expansion/contraction of the printing plate in the Y direction can be obtained from the position information of the alignment marks A and C. For example, information about the trapezoidal distortion of the printing plate, that is, information about the trapezoidal deformation of the printing plate can be obtained from the position information of the alignment marks A to D.

It is ideal that a line La passing through the alignment marks A and C of the printing plate 25 is parallel to the above-mentioned Y direction. However, when the printing plate 25 is mounted on the plate cylinder 24, the printing plate 25 is slightly inclined with respect to the plate cylinder 24. The mounting information of the printing plate 25 on the plate cylinder 24, for example, information about the inclination of the printing plate 25 with respect to the plate cylinder 24 in the Y direction, or the like can be obtained from the position information of the alignment marks A to D.

An ink ejection starting position, the position of the ink jet head 40, and the ejection timing of ink are corrected using the above-mentioned obtained various kinds of information. Publicly known methods of correcting the ejection of ink droplets using an ink jet method can be used to correct all of the ink ejection starting position, the position of the ink jet head 40, and the ejection timing of ink.

Further, publicly known correction methods can be used to correct expansion/contraction in the X direction, expansion/contraction in the Y direction, inclination, and trapezoidal correction for pattern data.

The number of the alignment marks may be at least three; and information about the expansion/contraction of the printing plate in the X direction, the inclination angle θ of the printing plate, and the expansion/contraction of the printing plate in the Y direction can be obtained. Since information about the trapezoidal distortion of the printing plate 25 can also be obtained when the number of the alignment marks is four, it is preferable that the number of the alignment marks is four. In addition, when a plurality of alignment marks are provided even inside the alignment marks A to D, non-linear correction can be performed. In this case, publicly known correction methods can also be used for correction using the alignment marks.

The laser displacement meter 44 is to measure a distance between the ink jet head 40 and the surface 25a of the printing plate 25. A distance between the alignment marks A and C in the Y direction, that is, a length AC is changed due to the swelling of the plate, which is caused by ink, or a change, which is caused by temperature, in the sum of the diameter of the plate cylinder and the thickness of the plate. Here, since the ink of the ink jet head 40 is ejected at the timing of the rotary encoder, the ink of the ink jet head 40 corresponds to a change in the length of the plate without being affected by a change in the diameter of the plate cylinder. However, when ink is transferred to the substrate 31, a distance is changed.

In order to make the length of a printing pattern, which is formed on the substrate 31, constant even though the above-mentioned length AC is changed, a change in the sum of the diameter of the plate cylinder and the thickness of the plate is measured by the laser displacement meter 44. Correction is performed on the basis of the result of the measurement.

A specific example of correction includes a method that accurately measures a change in a distance between the rotating shaft 24b of the plate cylinder 24 and the surface of the surface 25a of the printing plate 25 and changes the relative moving speeds of the plate cylinder 24 and the substrate 31 at the time of transfer on the basis of the result of the measurement.

Other than the above-mentioned specific example of correction, the specific example of correction includes, for example, a method that measures the temperature of the plate cylinder 24 or the environment and changes the relative moving speeds of the plate cylinder 24 and the substrate 31 at the time of transfer on the basis of a table, which is prepared in advance, of a relationship between temperature and the distance between the rotating shaft 24b of the plate cylinder 24 and the surface 25a of the printing plate 25.

Printing can be accurately performed by the above-mentioned specific example of correction even though the swelling of the plate or a change in the diameter of the plate cylinder occurs. It is known that the dimension of a transfer pattern in a feed direction is changed when a feed speed on the plate and a feed speed on the substrate are different from each other at the time of transfer.

As long as the laser displacement meter 44 can measure a distance between the ink jet head 40 and the surface 25a of the printing plate 25, the structure of the laser displacement meter 44 is not particularly limited.

Further, the laser displacement meter 44 can measure a change in the sum of the diameter of the plate cylinder and the thickness of the plate by measuring a distance to the surface 25a of the printing plate 25. This can be used for expansion/contraction in the Y direction. For example, when the diameter of the plate cylinder 24 or the thickness of the printing plate 25 is changed due to a temperature change, the length of the printing plate 25 between the alignment marks A and the alignment marks C is changed. A change in this length can be used for the correction of pattern data.

Each of the reading units 47 is to read the scale 27 of the printing plate 25, and the position information data of the printing plate 25 is obtained. The reading result of the reading unit 47 is output to the adjustment unit 16 and an encoder signal corresponding to the scale 27 is generated by the signal generation part 16a.

As long as the reading unit 47 can read the scale 27, the structure of the reading unit 47 is not particularly limited. If the scale 27 is an optically readable scale, for example, a reading unit, which optically reads the scale 27, is used as the reading unit 47. For example, products manufactured by RENISHAW and HEIDENHAIN can be used as the reading unit 47. More specifically, scanning heads for a linear encoder of RG2, TONiC (registered trademark), and SiGNUM (registered trademark) manufactured by RENISHAW can be used in accordance with the scale 27. Further, scanning heads for a linear encoder of AK LIDA 48, AK LIDA 47, LIP 4×1 A, and LIP 4×1 R manufactured by HEIDENHAIN can be used.

As long as the reading unit 47 can read the scale 27, a position at which the reading unit 47 is provided is not particularly limited. However, since the reading units 47 are provided on the carriage 46 even though the position of the ink jet head 40 with respect to the position of printing plate 25 deviate due to vibration, the reading units 47 are not affected by the deviation in position. For this reason, it is preferable that the reading units 47 are mounted on the carriage together with the ink jet head 40.

It is possible to improve alignment accuracy by using the alignment camera 42, the laser displacement meter 44, and the reading units 47 as described above. In the printing apparatus 10, the alignment camera 42, the laser displacement meter 44, and the reading units 47 are used to form a thin-film transistor as described below. Even though a difference of about 10 μm is present in a thin-film transistor, the characteristics of the thin-film transistor different from designed characteristics are obtained. In a case in which a plurality of thin-film transistors are formed, the characteristics of the thin-film transistors vary even though a difference of about 10 μm is present. Accordingly, in a case in which a thin-film transistor is used in, for example, electronic paper, high performance cannot be obtained. However, a variation in characteristics can be suppressed.

The rotating unit 49 is to rotate the ink jet head 40 about a line perpendicular to the surface 24a of the plate cylinder 24. The direction of the ink jet head 40 can be made to correspond to the inclination of the printing plate 25 by the rotating unit 49.

As shown in FIG. 3, a plurality of nozzles 41 are arranged in zigzag in the ink jet head 40 over the length of the ink jet head 40 corresponding to the entire width of the printing plate 25.

When zigzag arrangement is applied, the nozzles 41 can be densely arranged. The number of rows in which the nozzles 41 are to be arranged is not particularly limited, and may be one or two or more. Further, the nozzles 41 may be arranged in the form of a matrix.

The structure of the ink jet head 40 is not particularly limited, and may have, for example, the structure shown in FIG. 4. An ink jet head 40 shown in FIG. 4 includes a plurality of head modules 40a that are connected in the X direction. In this case, the structure of the ink jet head 40 is not limited to a structure in which the plurality of head modules 40a are connected in line, and may be a structure in which the plurality of head modules 40a are joined in zigzag.

In the ink jet head 40 shown in FIG. 4, the ejection waveform of each head module 40a can be adjusted by the ejection control unit 43. Furthermore, if the ejection control unit 43 is provided for each head module 40a, each of the ejection control units 43 can adjust an ejection waveform.

A method of ejecting ink in the ink jet head 40 is not particularly limited. Various methods, such as a piezoelectric method of ejecting liquid using the bending deformation, the shear deformation, the longitudinal vibration, and the like of a piezoelectric element, a thermal method of ejecting ink using a film boiling phenomenon by heating liquid, which is present in a liquid chamber, with a heater, and an electrostatic method using an electrostatic force, can be used as the method of ejecting ink in the ink jet head 40.

Next, an ink supply mechanism of the printing apparatus 10 will be described.

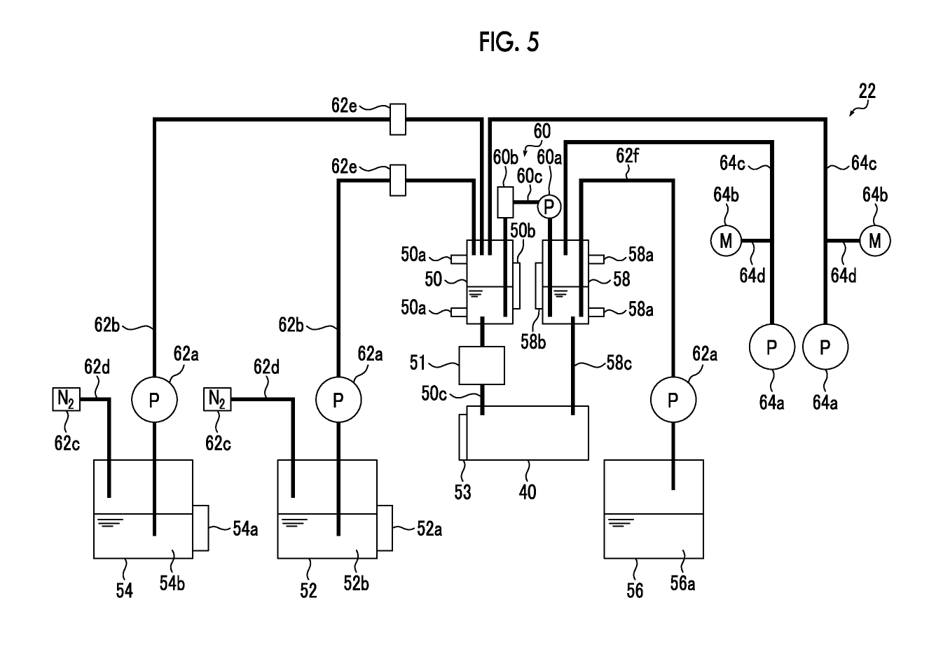

FIG. 5 is a schematic diagram showing the ink supply mechanism of the printing apparatus of the embodiment of the invention.

As shown in FIG. 5, in the image recording section 22, two sub-tanks 50 and 58 are connected to the ink jet head 40 through pipes 50c and 58c, respectively. The pipe 50c is provided with a deaeration unit 51. The deaeration unit 51 is to deaerate ink to be supplied to the ink jet head 40, and publicly known units can be appropriately used as the deaeration unit 51.

The sub-tank 50 is to store ink to be supplied to the ink jet head 40. The sub-tank 50 is provided with two water level sensors 50a and a temperature adjusting unit 50b.

As long as the water level sensor 50a can measure the level of ink, the structure of the water level sensor 50a is not particularly limited and publicly known sensors can be appropriately used as the water level sensor 50a.

The temperature adjusting unit 50b is to adjust the temperature of ink. Accordingly, the temperature of ink can be adjusted. It is preferable that the temperature of ink is in the range of, for example, about 15° C. to 30° C. As long as the temperature adjusting unit 50b can adjust the temperature of ink, the structure of the temperature adjusting unit 50b is not particularly limited and publicly known sensors can be appropriately used as the temperature adjusting unit 50b.

The sub-tank 58 is to store ink that is recovered from the ink jet head 40. The sub-tank 58 is provided with two water level sensors 58a and a temperature adjusting unit 58b.

Since the water level sensor 58a has the same structure as the water level sensor 50a, the detailed description of the water level sensor 58a will be omitted. Since the temperature adjusting unit 58b also has the same structure as the temperature adjusting unit 50b, the detailed description of the temperature adjusting unit 58b will be omitted.

There is a circulation unit 60 that moves the ink of the sub-tank 58 to the sub-tank 50. The circulation unit 60 includes a pipe 60c that connects the sub-tank 50 to the sub-tank 58, and a pump 60a and a filter 60b that are provided on the pipe 60c. The pump 60a is to adjust the amount of ink of the sub-tank 50 and the amount of ink of the sub-tank 58. As long as the pump 60a can move ink between the sub-tanks 50 and 58, the structure of the pump 60a is not particularly limited and publicly known pumps can be appropriately used as the pump 60a. Ink, which is moved to the sub-tank 50 from the sub-tank 58, passes through the filter 60b, and the filter 60b removes dirt and the like at this time.

Pipes 64c are inserted into the sub-tanks 50 and 58 and are provided with pumps 64a, respectively. Further, pressure sensors 64b are connected to the pipes 64c through pipes 64d, respectively. Although not shown, valves and the like are provided on the pipes 64c and 64d. Accordingly, the sub-tanks 50 and 58 are filled with nitrogen gas. Furthermore, when the amount of nitrogen gas with which the sub-tank is filled is changed, a difference is generated between the pressure of the sub-tank 50 and the pressure of the sub-tank 58. Therefore, ink can be easily circulated.

The pressure of the sub-tank 50 and the pressure of the sub-tank 58 can be measured by the pressure sensors 64b. It is possible to control the meniscus negative pressure and the amount of ink, which is to be circulated, of the ink jet head 40 by using the results of the measurement of the pressure of the pressure of the sub-tank 50 and the pressure of the sub-tank 58 that are measured by the pressure sensors 64b.

An ink tank 52 is connected to the sub-tank 50 through a pipe 62b. The pipe 62b is provided with a pump 62a and a filter 62e. The ink tank 52 is filled with ink 52b.

The ink tank 52 is provided with a temperature adjusting unit 52a. Since the temperature adjusting unit 52a has the same structure as the temperature adjusting unit 50b, the detailed description of the temperature adjusting unit 52a will be omitted.

Further, a bomb 62c, which is filled with, for example, nitrogen gas, is connected to the ink tank 52 through a pipe 62d. Accordingly, the ink tank 52 is filled with nitrogen gas.

Furthermore, a cleaning solution bottle 54 is connected to the sub-tank 50 through a pipe 62b. The pipe 62b is provided with a pump 62a and a filter 62e. The cleaning solution bottle 54 is filled with a cleaning solution 54b.

The cleaning solution bottle 54 is provided with a temperature adjusting unit 54a. Since the temperature adjusting unit 54a has the same structure as the temperature adjusting unit 50b, the detailed description of the temperature adjusting unit 54a will be omitted.

Further, a bomb 62c, which is filled with, for example, nitrogen gas, is connected to the cleaning solution bottle 54 through a pipe 62d. Accordingly, the cleaning solution bottle 54 is filled with nitrogen gas.

The temperature of ink can be adjusted by the temperature adjusting unit 52a, but it is preferable that the temperature of ink of the sub-tank 50 is higher than the temperature of ink of the ink tank 52.

A waste liquid tank 56 is connected to the sub-tank 58 through a pipe 62f. A pump 62a is connected to the pipe 62f. Accordingly, the ink 52b stored in the sub-tank 58 can be moved into the waste liquid tank 56 as waste liquid.

Nano-metal ink for ink jet can be used as the ink 52b. Specifically, Ag nano-metal ink (Ag1teH (model number), L-Ag1TeH (model number)) manufactured by ULVAC Technologies, Inc. and Au nano-metal ink (cyclododecene solvent) ink jet type can be used as the ink 52b.

Next, the printing plate 25 will be described.

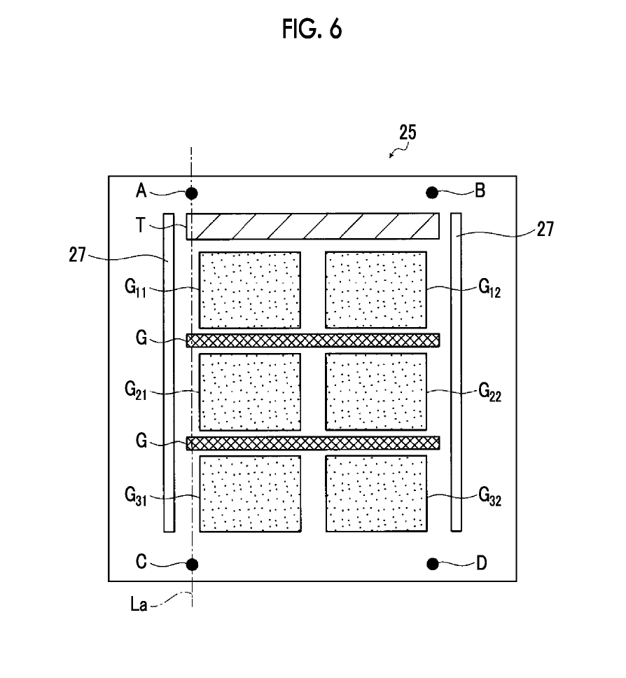

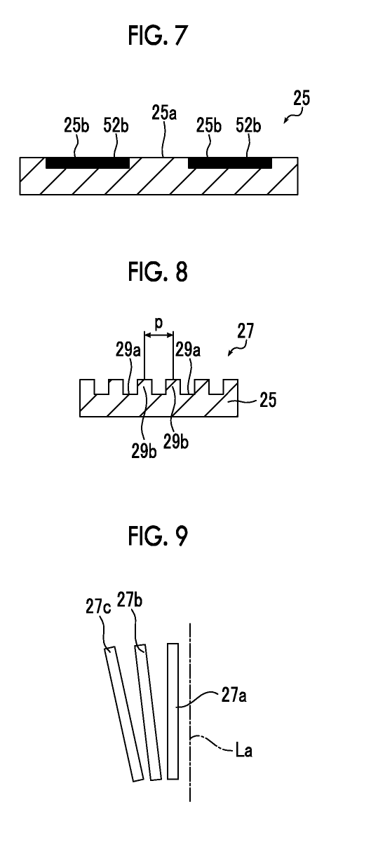

FIG. 6 is a schematic diagram showing an example of the printing plate that is used in the printing apparatus of the embodiment of the invention, FIG. 7 is a schematic cross-sectional view showing the example of the printing plate that is used in the printing apparatus of the embodiment of the invention, FIG. 8 is a schematic cross-sectional view showing the structure of the scale, and FIG. 9 is a schematic diagram showing another example of the scale.

As shown in FIG. 6, for example, the alignment marks A to D are provided at four corners on the printing plate 25, respectively. An ejection confirmation area T, printing areas G₁₁ and G₁₂, a spit area G, printing areas G₂₁ and G₂₂, a spit area G, and printing areas G₃₁ and G₃₂ are formed on the printing plate 25. In addition, the scales 27 are formed on both sides of the ejection confirmation area T, the printing areas G₁₁, G₁₂, G₂₁, G₂₂, G₃₁, and G₃₂, and the spit areas G. The scales 27 are formed in a direction parallel to the line La passing through the alignment marks A and C. One scale 27 may be formed on at least one side of the ejection confirmation area T, the printing areas G₁₁, G₁₂, G₂₁, G₂₂, G₃₁, and G₃₂, or the spit areas G.

The ejection confirmation area T is an area to which ink is to be ejected in the shape of a test pattern by the ink jet head 40. After being evaluated, the ink of the ejection confirmation area T is removed by the cleaning unit 34 or is removed by being transferred to the substrate 31.

The spit areas G are areas to which ink is ejected through a normal ejection operation by the ink jet head 40 and which are used for the confirmation of ejection.

Since areas used for the confirmation of ejection, that is, the ejection confirmation area T and the spit areas G are provided in front of the printing areas G₁₁ to G₃₁ and G₁₂ to G₃₂, ink can be reliably ejected to the printing areas G₁₁ to G₃₁ and G₁₂ to G₃₂.

For example, recessed portions 25b are formed on the printing plate 25 as shown in FIG. 7. The ink 52b is ejected into the recessed portions 25b in the form of droplets, so that ink is applied in the shape of a pattern. The depth of the recessed portion 25b is about several μm.

The material of the printing plate 25 is not limited to a resin, metal, glass, and the like. However, when a resin plate is used as the printing plate 25, printing is easily performed on a brittle material such as glass since the printing plate 25 has elasticity and printing pressure can be lowered. Various elastomers, such as fluorosilicone rubber, butyl rubber, ethylene-propylene rubber, nitrile rubber, neoprene rubber, Hypalon rubber, and urethane rubber, can be used for the printing plate 25; and silicone rubber having high releasability, such as polydimethylsiloxane (PDMS), fluororubber, and the like are desirable. Since the transferability of ink is improved when polydimethylsiloxane (PDMS) and the like are used for the printing plate 25, the remaining of ink on the printing plate 25 after transfer is suppressed. Accordingly, continuous printing can be performed even though the printing plate 25 is not cleaned. Therefore, printing efficiency can be improved.

A plate on which recessed portions 25b are formed in a predetermined pattern is used as the printing plate 25, and the recessed portions 25b are formed by a publicly known method. For example, the printing plate 25 is formed by general means, and is formed using the same means as, for example, a photolithography, imprint, an offset printing plate, and a flexographic printing plate.

The scales 27 are used to obtain position information on the printing plate 25. The scale 27 is not particularly limited, and is formed of, for example, an optically readable scale. Further, the scale 27 has, for example, a predetermined pitch, and the pitch is appropriately determined according to required accuracy or the like.

For example, the scales 27 are formed simultaneously with the formation of the printing pattern of the printing plate 25.

The printing plate 25 is formed by general means as described above. Further, when the above-mentioned means described in JP2005-81726A is used, the scale 27 can be formed of unevenness and a scale 27 having a lyophilic property and liquid repellency can also be formed.

It is preferable to enhance the optical contrast of the scales 27 to improve reading accuracy in a case in which the scales 27 are optically read by the reading units 47. In a case in which the scale 27 is formed of an uneven structure including recessed portions 29a and protruding portions 29b as shown in FIG. 8, the optical contrast of the scale 27 is low despite the formation of unevenness using the same material or a similar material. Accordingly, it is preferable that one layer made of a material different from the material of the printing plate 25 is provided on the printing plate 25 to enhance contrast. Since a process for forming the printing plate 25 becomes complicated in a case in which one layer having been described above is to be formed in the formation of the printing plate 25, an exclusive device for forming the printing plate 25 is required. Accordingly, it is preferable to form one layer, which is made of a material different from the material of the printing plate 25, by using an actual printing machine. A distance between the protruding portions 29b of the scale 27 is referred to as a pitch p of the scale 27. A distance between the recessed portions 29a of the scale 27 may be referred to as the pitch p. The output interval of the encoder signal, which is generated by the above-mentioned signal generation part 16a, is equal to the pitch p. Since the scales 27 are inclined with respect to the reading units 47 when the printing plate 25 is inclined, the output interval of the encoder signal is changed according to the inclination of the printing plate 25.

Further, since contrast is enhanced when inking is performed by the image recording section 22 and ink is made to adhere to the recessed portions 29a or the protruding portions 29b of the scales 27, the reading accuracy of the scales 27 can also be improved.

One the scale 27 has been formed on each of both sides of the ejection confirmation area T, the printing areas G₁₁, G₁₂, G₂₁, G₂₂, G₃₁, and G₃₂, and the spit areas G, but the scales 27 are not limited thereto. For example, a scale 27a parallel to the line La and scales 27b and 27c inclined with respect to the line La may be formed as shown in FIG. 9. Accordingly, if any one of the scales 27a, 27b, and 27c is parallel to the rotational direction of the plate cylinder 24 in a case in which the printing plate 25 is provided so as to be inclined with respect to the plate cylinder 24, the scale parallel to the rotational direction of the plate cylinder 24 can be used. The number of inclined scales is not limited to 2 shown in FIG. 9, and is appropriately determined according to required alignment accuracy, the size of the printing plate 25, the size of the image recording section 22, or the like.

Furthermore, the inclination angles, the pitch, and the like of the inclined scales 27b and 27c are stored in the storage section 14 in advance.

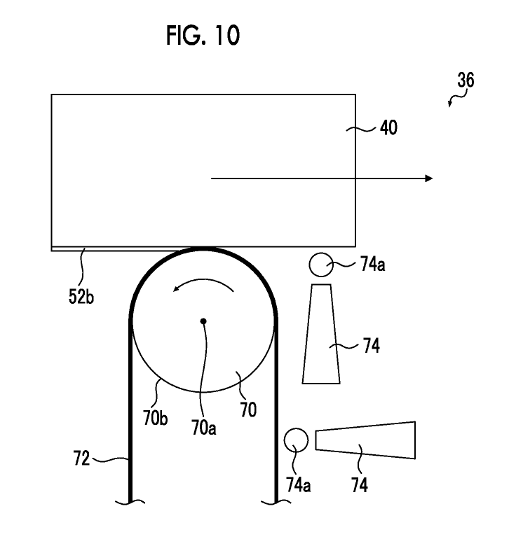

FIG. 10 is a schematic diagram showing an example of the maintenance section of the printing apparatus of the embodiment of the invention.

As shown in FIG. 10, a rotating roller 70 is disposed for the ink jet head 40. The rotating roller 70 includes a rotating shaft 70a and is rotated about the rotating shaft 70a. A web 72, which cleans the ink jet head 40, is wound on the peripheral surface 70b of the rotating roller 70. As long as the web 72 can remove the ink 52b of the ink jet head 40, the web 72 is not particularly limited. For example, a cleaning solution 74a is directly applied or sprayed to the ink jet head 40 by a cleaning part 74, and the web 72 comes into contact with the ink jet head 40 during the rotation of the rotating roller 70 to remove the ink 52b. Further, a cleaning solution 74a may be sprayed to the web 72 by a cleaning part 74, and the web 72 may come into contact with the ink jet head 40 during the rotation of the rotating roller 70 to remove the ink 52b.

For example, a solvent having ink solubility or a solution not containing solid of ink components is used as the cleaning solution. A hydrocarbon solvent can be used for Ag nano-metal ink (Ag1teH (model number), L-Ag1TeH (model number)) manufactured by ULVAC Technologies, Inc. and Au nano-metal ink (cyclododecene solvent) ink jet type. For example, toluene, xylene, hexane, tetradecane, and cyclododecene can be used as a hydrocarbon solvent.

For example, wiping cloth, such as SAVINA (registered trademark) manufactured by KB Seiren Ltd., TORAYSEE (registered trademark) manufactured by Toray Industries, Inc., and NANOFRONT (registered trademark) and MICROSTAR (registered trademark) manufactured by Teijin Ltd., can be used as the web 72.

Further, a member, which cleans the ink jet head 40, is not limited to the member shown in FIG. 10. For example, a structure including a rubber blade (not shown) can also be provided. Since the ink jet head 40 can be moved in the X direction by the carriage 46, the rubber blade is fixed and wipe off ink in the longitudinal direction of the ink jet head 40 by using the fact that the ink jet head 40 can be moved in the X direction by the carriage 46. Further, the ink jet head 40 may be fixed and the rubber blade may be scanned to wipe off ink. At this time, when ink is wiped off in a lateral direction orthogonal to the longitudinal direction of the ink jet head 40, there is a merit that the moving distance of the rubber blade can be made short. In addition, there is a merit that the ink having been wiped off is not likely to enter other nozzles. On the other hand, when ink is wiped off in a direction parallel to the longitudinal direction of the ink jet head 40, there is a merit that the X axis of the ink jet head 40 can be shared. Accordingly, the maintenance section may be designed in an optimum form in which the structure or cost of the apparatus is considered.

A cleaning solution may be applied to the rubber blade or the ink jet head 40 so that ink is wiped off. The pressure of the sub-tank 50 and the pressure of the sub-tank 58 at the time of the wipe of ink can be set separately from those at the time of printing. It is preferable that optimum pressure is set according to the condition of wipe, the ink jet head 40, or ink.

In a case in which a web (not shown) is used, the web is moved to wipe off ink while the ink jet head 40 is moved in, for example, the X direction. Accordingly, the surface of the web is always refreshed. The same web as the above-mentioned web 72 can be used as the web.

At least one of a method of wiping off ink after a cleaning solution is contained in a web in advance and a method of wiping off ink while applying a cleaning solution to the ink jet head 40 may be used. The pressure of the sub-tank 50 and the pressure of the sub-tank 58 at the time of the wipe of ink can be set separately from those at the time of printing. It is preferable that optimum pressure is set according to the condition of wipe, the ink jet head 40, or ink.

The maintenance section 36 can allow the ink jet head 40 to perform an operation, such as purge, spit, and drip.

Here, purge is to extrude ink from the nozzles 41 after the pressure of the sub-tank 50 is set to positive pressure in a state in which the ink jet head 40 is disposed above an ink receiver 77. The ink receiver 77 can be shared with a cap and a wipe part.

Spit is an operation for ejecting ink. Nozzle clogging and ejection bending can be improved by spit. Spit is performed at the same position as purge, but a station for spit may be provided. In this case, it is preferable that ejected ink is sucked from below not to scatter. At the time of spit, a drive voltage is made high in comparison with an ejection waveform in the ink jet head 40 at the time of printing or an exclusive waveform is used. The exclusive waveform is set so that the amount of ink droplets is large and the jetting frequency of ink is high in comparison with an ejection waveform at the time of printing.

Drip is not a recovery operation for extruding ink as strong as the above-mentioned purge and is an operation for recovering ink by dropping ink in a gentle pace. Accordingly, nozzle clogging and the ejection bending of ink can be improved by drip. Drip is also performed at the same position as purge or spit, but the pressure of the sub-tank 50 at the time of drip is set closer to positive pressure than the pressure thereof at the time of printing. However, it is preferable that the pressure of the sub-tank 50 is positive pressure higher than the atmospheric pressure and is lower than purge pressure.

Further, the maintenance section 36 may include a cap mechanism (not shown) to prevent the nozzles 41 from being dried. The cap mechanism is to fill the perimeter of the nozzles 41 with nitrogen gas after capping the nozzles 41. Furthermore, when a web or the like is soaked with a cleaning solution, and is disposed in a cap, it is also possible to further prevent the nozzles 41 from being dried.

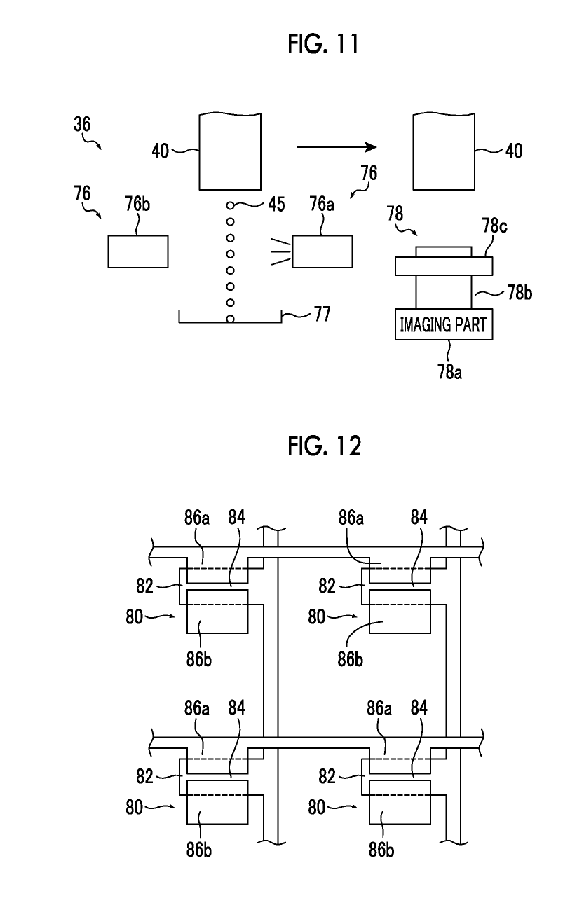

FIG. 11 is a schematic diagram showing an ejection observation unit and a nozzle observation unit of the maintenance section of the printing apparatus of the embodiment of the invention.

As shown in FIG. 11, the maintenance section 36 includes an ejection observation unit 76 that observes ink droplets 45 ejected from the ink jet head 40 and a nozzle observation unit 78 that observes the nozzles 41 (see FIG. 3) of the ink jet head 40 from the surface of the ink jet head 40 on which the nozzles 41 are formed. The ink receiver 77, which receives the ink droplets 45, is disposed so as to face the ink jet head 40.

The ejection observation unit 76 includes a light source 76a and an imaging part 76b, and the light source 76a and the imaging part 76b are disposed with the ink droplets 45 interposed therebetween. A LED light source and a stroboscopic light source can be used as the light source 76a. For example, NANO PULSE LIGHT manufactured by Sugawara Seisakusho Co., Ltd. can be used as the stroboscopic light source.

For example, a camera including a camera lens can be used as the imaging part 76b. For example, a camera lens, which has an optical magnification in the range of 0.5 to 10 and a working distance of 30 mm or more, is used as the camera lens. For example, a camera, which includes a monochrome CMOS or a monochrome CCD having about one million pixels or more, is used as the camera. Since the ejection observation unit 76 observes the shadows of the ejected ink droplets 45, a color camera does not need to be used in the ejection observation unit 76.

In the nozzle observation unit 78, one end of a lens 78b is connected to an imaging part 78a and a light source 78c is provided at the other end of the lens 78b.

For example, a camera, which includes a monochrome CMOS or a monochrome CCD having about one million pixels or more, is used as the imaging part 78a, and both a color camera and a monochrome camera can be used as the imaging part 78a.

For example, a camera lens, which has an optical magnification in the range of 0.5 to 10, is used as the lens 78b. Since there is a possibility that ink adheres to the camera lens, it is preferable that a protective filter, which is easily replaced or cleaned, is provided on the camera lens.

The imaging part 78a and the lens 78b may be formed integrally with each other and may be formed separately from each other. A camera including a camera lens can be used in a case in which the imaging part 78a and the lens 78b may be formed integrally with each other.

For example, a LED light source can be used as the light source 78c, and a coaxial illumination, a ring illumination, or the like can be used as the light source 78c.

Since both the ejection observation unit 76 and the nozzle observation unit 78 are connected to the control section 18, the operations of the light sources 76a and 78c and the imaging parts 76b and 78a are controlled by the control section 18 and imaging data obtained from the imaging parts 76b and 78a are stored in the storage section 14 by the control section 18. The state of the ejection of ink from the ink jet head 40 is compared with, for example, a design value of the ejection characteristics of the ink jet head 40 by the control section 18, and the result of the comparison is stored in the storage section 14.

The printing apparatus 10 of the invention can form a gate electrode, a source electrode, and a drain electrode of a thin-film transistor used in, for example, electronic paper and the like.

FIG. 12 is a schematic diagram showing an example of a thin-film transistor that is formed by the printing apparatus of the embodiment of the invention.

A thin-film transistor 80 (hereinafter, referred to as a TFT 80) shown in FIG. 12 includes a gate electrode 82, a gate insulating layer (not shown), a source electrode 86a, a drain electrode 86b, a semiconductor layer (not shown), and a protective layer (not shown).

The gate insulating layer (not shown) is formed in the TFT 80 so as to cover the gate electrode 82. The source electrode 86a and the drain electrode 86b are formed on the gate insulating layer with a preset gap, which serves as a channel area 84, interposed therebetween. A semiconductor layer (not shown), which functions as an active layer, is formed on the channel area 84. The protective layer (not shown), which covers the semiconductor layer, the source electrode 86a, and the drain electrode 86b, is formed.

Next, the inclination correction of the printing plate 25 of the printing apparatus 10 will be described.

When the printing plate 25 is mounted on the plate cylinder 24, the inclination of the printing plate 25 occurs. For this reason, since the scales 27 are also inclined, the pattern of inking to be performed on the printing plate 25 also needs to be adjusted according to the inclination of the scales 27.

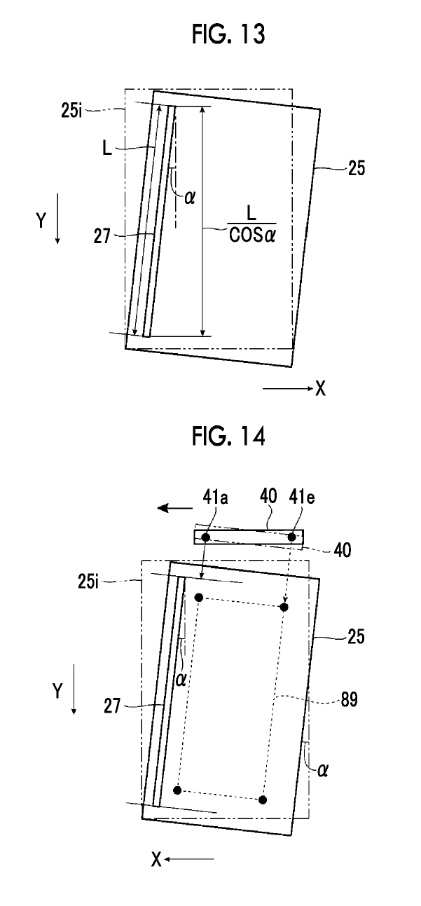

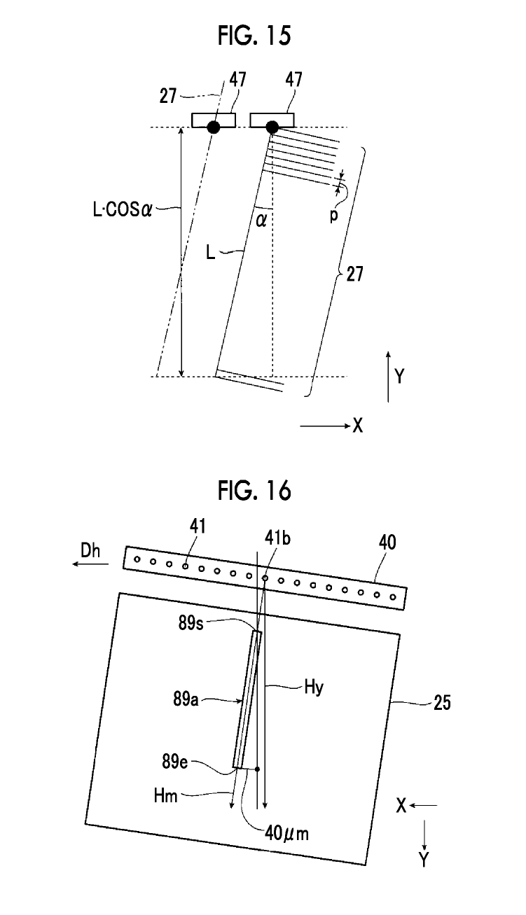

First and second examples of the inclination correction of the printing plate 25 of the printing apparatus 10 will be described with reference to FIGS. 13, 14, and 15, but a method of correcting inclination is not limited to methods to be described below. At least one of the inclination correction shown in FIG. 13 or the inclination correction shown in FIGS. 14 and 15 may be used as the inclination correction of the printing plate 25 in the printing apparatus 10. The structure of the printing apparatus 10 may include components that are used for any of the inclination correction shown in FIG. 13 and the inclination correction shown in FIGS. 14 and 15.

Here, FIG. 13 is a schematic diagram illustrating a first example of the inclination correction of the printing apparatus of the embodiment of the invention. FIG. 14 is a schematic diagram illustrating a second example of the inclination correction of the printing apparatus of the embodiment of the invention, and FIG. 15 is an enlarged schematic diagram of main parts of FIG. 14. The ideally disposed printing plate 25i is shown in FIGS. 13 and 14 by an imaginary line. “Ideally disposed” means that the Y direction of the plate cylinder 24 and the line La passing through the alignment marks A and C of the printing plate 25 are parallel to the above-mentioned Y direction.

First, the first example of the inclination correction of the printing plate 25 will be described. As shown in FIG. 13, the scale 27 and a pattern 89 are also inclined at an angle α in a case in which the printing plate 25 is disposed so as to be inclined at an angle α with respect to the ideally disposed printing plate 25i. In this state, the scale 27 is read in a direction parallel to the Y direction by the reading unit 47. In a case in which the length of the scale 27 is L, the read length of the scale 27 is L/cos α. Accordingly, the read length of the scale 27 is increased according to the inclination angle α. For this reason, a pattern to be formed is also lengthened l/cos α times. For example, when the pattern is lengthened in a case in which a thin-film transistor is to be formed, there is a concern that characteristics cannot be exhibited as designed. Further, since a timing at which the scale 27 is read by the reading unit 47 also deviates by l/cos α, that is, the output interval of the encoder signal deviates by l/cos α, the ejection timing of ink deviates. Accordingly, since the ejection position of an ink droplet deviates, the position of a dot formed by the ink droplet deviates. For this reason, there is a concern that inking cannot be performed with high accuracy.

Therefore, in a case in which the printing plate 25 is disposed so as to be inclined at an angle α as described above, the correction part 16c corrects the pattern data of the pattern 89, which is to be formed, by multiplying the pattern data of the pattern 89 by cos α. The correction part 16c creates corrected pattern data by correcting the ejection pattern data of ink. The pattern is formed using the corrected pattern data.

The plurality of scales 27a to 27c are prepared as shown in FIG. 9 and a scale corresponding to the inclination of the printing plate 25 is selected, so that a deviation in read length in the reading unit 47 can be suppressed.

Next, the second example of the inclination correction of the printing plate 25 will be described. In a case in which the printing plate 25 is disposed so as to be inclined at an angle α with respect to the ideally disposed printing plate as shown in FIG. 14, the scale 27 is also inclined at an angle α. In this state, the scale 27 is read in a direction parallel to the Y direction by the reading unit 47. In a case in which the length of the scale 27 is L, the read length of the scale 27 is L/cos α. Accordingly, the read length is increased according to the inclination angle α. For this reason, a pattern to be formed is also lengthened l/cos α times. For example, when the pattern is lengthened in a case in which a thin-film transistor is to be formed, there is a concern that characteristics cannot be exhibited as designed. Further, since a timing at which the scale 27 is read by the reading unit 47 also deviates by l/cos α, that is, the output interval of the encoder signal deviates by l/cos α, the ejection timing of ink deviates. Accordingly, since the ejection position of an ink droplet deviates, the position of a dot formed by the ink droplet deviates. For this reason, there is a concern that inking cannot be performed with high accuracy.

Furthermore, when the reading unit 47 is not scanned in the X direction in this state, the read length of the scale 27 is L/cos α and the interval of the scale is pitch p/cos α. When the reading unit 47 is scanned in the X direction by the carriage 46 as shown in FIG. 15, the read length of the scale 27 is L·cos α and the interval of the scale is pitch p·cos α. However, even though the reading unit 47 is scanned in the X direction, the read length of the scale 27 is not L.

Since timings at which ink is ejected by nozzles 41a and 41e positioned at both ends of the ink jet head 40 deviate from each other in a case in which the reading unit 47 is scanned in the X direction, the landing positions of ink in the Y direction deviate from each other. As a result, inking cannot be accurately performed in a pattern on the printing plate 25. For this reason, the timings at which ink is ejected by the nozzles 41a and 41e, for example, the ejection waveforms of ink are adjusted by the adjustment part 16b. Further, the ink jet head 40 is rotated so as to correspond to the inclination angle α of the printing plate 25. Accordingly, a deviation in the landing position of ink can be suppressed in the Y direction. That is, the inclination of the printing plate 25 can be corrected.

Furthermore, in a case in which the printing plate 25 is disposed so as to be inclined at an angle α with respect to the ideally disposed printing plate as shown in FIG. 14, the scale 27 is also inclined at an angle α, the ink jet head 40 is rotated at an angle α by the rotating unit 49 (see FIG. 2). Then, the carriage 46 is moved in the X direction so that the ink jet head 40 can form the pattern 89. The moving distance of the carriage 46 in the X direction is appropriately determined by the correction part 16c from the comparison of a distance between the nozzles that are positioned at both ends of the ink jet head 40 and the width of the pattern 89 to be formed. The inclination of the printing plate 25 can be corrected even in this way.

The second example of the inclination correction of the printing plate 25 will be described in more detail. For example, in a case in which the printing plate 25 is inclined so that the position of a wiring pattern 89a, which is parallel to the rotational direction Y, at a printing start position 89s and the position thereof at a printing end position 89e deviate from each other by 40 μm in the X direction as shown in FIG. 16, the position of the nozzle 41b needs to be moved in, for example, a direction Dh parallel to the X direction in accordance with a deviation of 40 μm in the position of the wiring pattern 89a in order to form the wiring pattern 89a by inking that is performed by one nozzle 41b. That is, the ink jet head 40 needs to be moved in the direction Dh. In FIG. 16, reference character Hy denotes the moving direction of the nozzle 41b when the ink jet head 40 is not moved in the direction Dh. The moving direction Hy is a direction parallel to the Y direction. Reference character Hm denotes the moving direction of the nozzle 41b when the ink jet head 40 is moved in the direction Dh. The moving direction Hm is a direction parallel to the X direction.

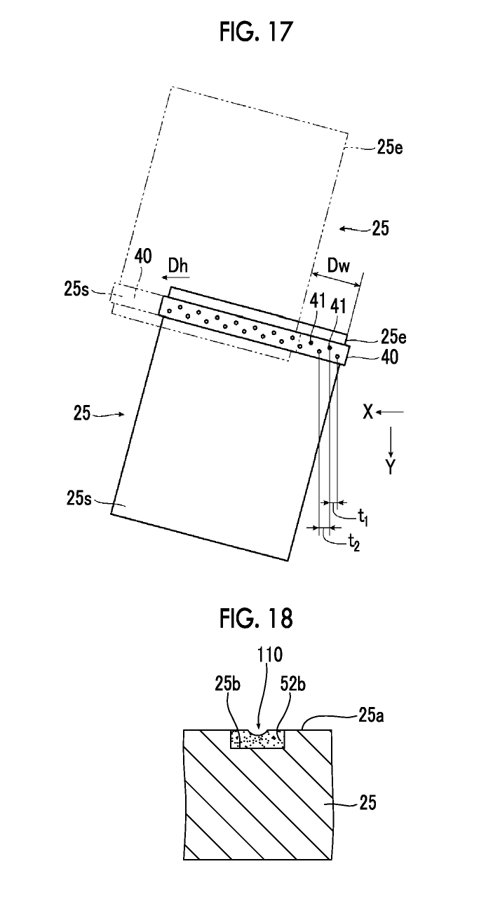

Further, for example, in a case in which the ink jet head 40 in which nozzles 41 are arranged in zigzag is used when the printing plate 25 is inclined as shown in FIG. 17, intervals t1 and t2 of the nozzles 41 satisfy “t1<t2” and the intervals t1 and t2 of the nozzles 41 become non-uniform if the ink jet head 40 is inclined. For this reason, the ink jet head 40 needs to be moved in, for example, the direction Dh so that the ink jet head 40 is always disposed at a constant position above the inclined printing plate 25. Specifically, when the printing plate 25 is inclined in a case in which the position of the ink jet head 40 is fixed, a positional deviation corresponding to a distance Dw is generated at a printing plate start position 25s and a printing plate end position 25e. For this reason, it is possible to always dispose the ink jet head 40 at a constant position above the printing plate 25 by moving the ink jet head 40 in the direction Dh in accordance with the moving distance of the printing plate 25 in the Y direction.

Since the inclination of the printing plate 25 is corrected as described above by a method of correcting the inclination of the printing plate 25, a deviation in the ejection position of an ink droplet is suppressed and a pattern can be formed on the printing plate 25 with high accuracy without the change of the size, the position, and the like of the pattern even though the printing plate 25 is mounted so as to be inclined. Accordingly, it is possible to improve printing accuracy even in a case in which the mounting accuracy of the printing plate 25 is low.

The allowable range of the inclination of the printing plate 25 is set as described above, and the inclination of the printing plate 25 may be not corrected if the inclination of the printing plate 25 is in the allowable range.

Next, a wiring pattern formed by the printing apparatus 10 will be described.

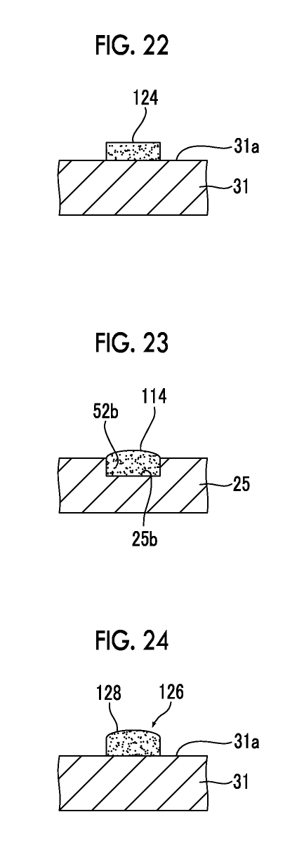

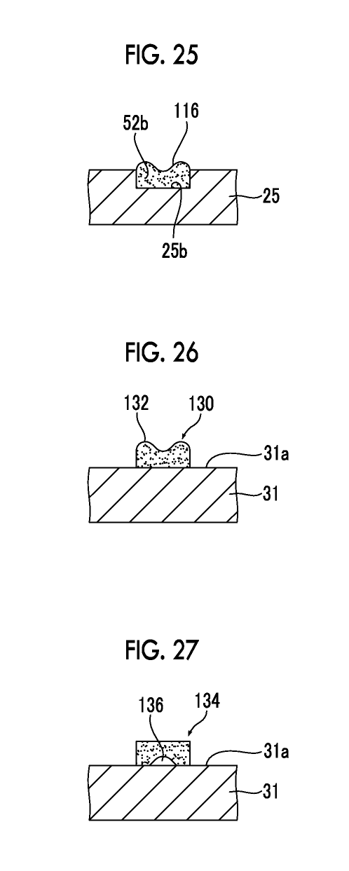

Here, FIGS. 18 to 20 are schematic cross-sectional views showing steps of forming a wiring pattern, which is formed by the printing apparatus of the embodiment of the invention, in the order of steps. FIG. 21 is a schematic cross-sectional view showing a first example of the printing plate from which ink is not yet transferred, and FIG. 22 is a schematic cross-sectional view showing a pattern that has been transferred to the printing plate. FIG. 23 is a schematic cross-sectional view showing a second example of the printing plate from which ink is not yet transferred, and FIG. 24 is a schematic cross-sectional view showing a pattern that has been transferred to the printing plate. FIG. 25 is a schematic cross-sectional view showing a third example of the printing plate from which ink is not yet transferred, FIG. 26 is a schematic cross-sectional view showing an example of a pattern that has been transferred to the printing plate, and FIG. 27 is a schematic cross-sectional view showing another example of the pattern that has been transferred to the printing plate.

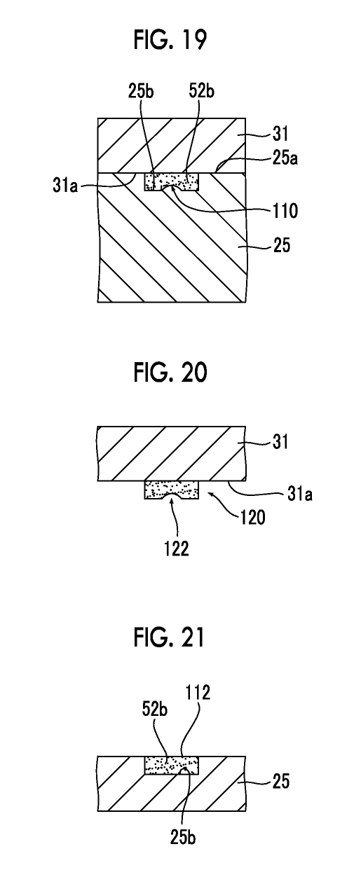

In regard to the wiring pattern formed by the printing apparatus 10, ink 52b is ejected into the recessed portion 25b of the printing plate 25 in the form of droplets, so that the shape of ink having a recessed portion 110 at the center thereof is formed as shown in FIG. 18. When the printing plate 25 is pushed against the substrate 31 in this state as shown in FIG. 19 and the ink is transferred to the surface 31a of the substrate 31 as shown in FIG. 20, a wiring pattern 120 having a recessed portion 122 is formed.

The shape of ink on the printing plate 25 and the shape of the wiring pattern 120 can be measured by, for example, a confocal microscope (OPTELICS H1200 manufactured by Lasertec Corporation) and a microfigure measuring instrument SURFCORDER (ET4000-L manufactured by Kosaka Laboratory Ltd.).

In regard to the wiring pattern 120 (see FIG. 20) formed as described above, it was found that the shape of ink, which is present on the printing plate 25 and is not yet transferred, is transferred to the surface 31a of the substrate 31 just as it is. For example, in a case in which the shape of ink on the printing plate 25 is the shape of ink having the recessed portion 110 at the center thereof as shown in FIG. 18, that is, a so-called coffee-stain shape, the shape of ink on the substrate 31 is also the shape of ink having the recessed portion 122 at the center thereof as in the case of the wiring pattern 120 shown in FIG. 20, that is, a so-called coffee-stain shape.

Since ink is transferred to the substrate 31 from the plate cylinder 24 so that the wiring pattern 120 is formed, it is thought that the wiring pattern 120 has an inverted shape of the shape of ink on the printing plate 25. However, the wiring pattern 120 did not actually have an inverted shape. The mechanism of the transfer of ink to the substrate 31 is not clear, but the reason for this is thought that polydimethylsiloxane (PDMS) is deformed by printing pressure at the time of transfer and the substrate, ink, and the printing plate (polydimethylsiloxane (PDMS)) are in close contact with each other since polydimethylsiloxane (PDMS) is used for the printing plate 25.

This implies that the cross-sectional shape of the wiring pattern can be freely controlled by the control of the shape of ink not yet transferred and present on the printing plate.

Since a method of controlling the coffee-stain shape of ink by changing the volatile state of ink is known, a shape corresponding to the specifications of a wiring pattern can be formed by ink design. Further, since it is known that polydimethylsiloxane (PDMS) absorbs a solvent, the same effects can be obtained from the control of the amount of a solvent to be absorbed by the polydimethylsiloxane (PDMS).

For example, in a case in which a surface 112 of the ink 52b is flat on the printing plate 25 as shown in FIG. 21, a wiring pattern 124 of which a surface is flat is formed on the surface 31a of the substrate 31 as shown in FIG. 22.

Further, for example, in a case in which a surface 114 of the ink 52b is convex on the printing plate 25 as shown in FIG. 23, a wiring pattern 126 of which a surface 128 is convex is formed on the surface 31a of the substrate 31 as shown in FIG. 24.

Furthermore, for example, in a case in which a surface 116 of the ink 52b is concave on the printing plate 25 as shown in FIG. 25, a wiring pattern 130 of which a surface 132 is concave is formed on the surface 31a of the substrate 31 as shown in FIG. 26.

The ink 52b of which the surface 116 is concave is shown in FIGS. 25 and 26, but a wiring pattern 134, which is shown in FIG. 27 and has a recessed portion 136 formed on the side thereof facing the surface 31a of the substrate 31, is not formed.

Next, a method of forming a pattern will be described. The pattern is formed by the ejection of ink droplets of four times.

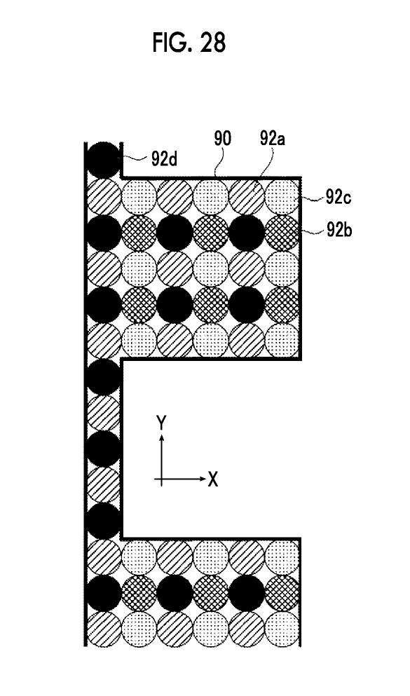

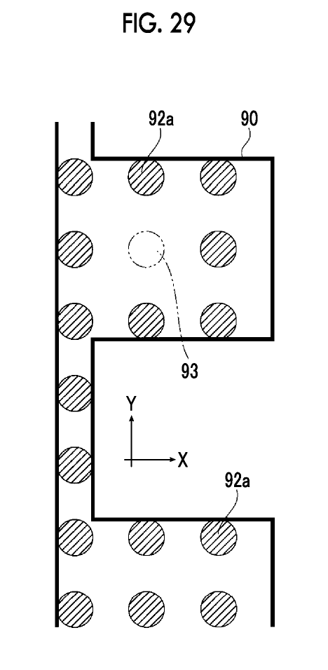

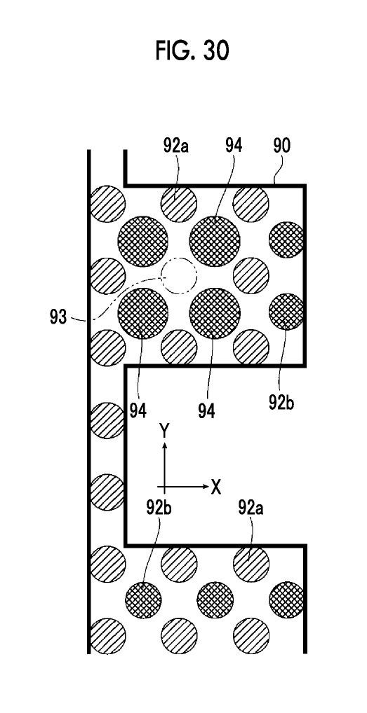

FIG. 28 is a schematic diagram showing a state in which ink has been applied to a pattern, FIG. 29 is a schematic diagram showing a state in which first ink has been applied to the pattern, and FIG. 30 is a schematic diagram showing a state in which second ink has been applied to the pattern. The pattern 90 shown in FIG. 28 is formed by the ejection of ink droplets of, for example, four times.

In FIG. 28, reference numeral 92a denotes dots formed by first ink droplets, reference numeral 92b denotes dots formed by second ink droplets, reference numeral 92c denotes dots formed by third ink droplets, and reference numeral 92d denotes dots formed by fourth ink droplets.

After the ejection of the first ink droplets, the plate surface observation unit 26 images the surface of the plate and obtains plate surface-imaging data and the determination part 16d of the adjustment unit 16 performs determination. As a result, in a case in which ink is not ejected due to the malfunction of the ink jet head 40 or the like and a deficient portion 93 is present among the dots 92a formed by first ink droplets as shown in FIG. 29, the amount of ink to be ejected from the ink jet head 40 is changed by the control section 18 at the time of the ejection of the second ink droplets. Accordingly, ink droplets are ejected at the time of the second ejection of ink so that dots 94 having a large size are formed to surround the deficient portion 93 as shown in FIG. 30. Therefore, an appropriate pattern 90 can be formed.

Next, another example of the method of forming a pattern will be described.

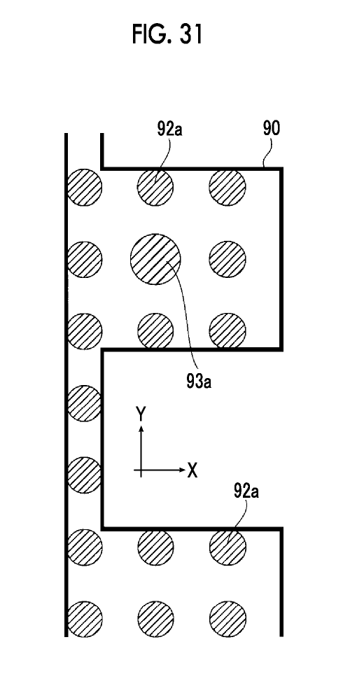

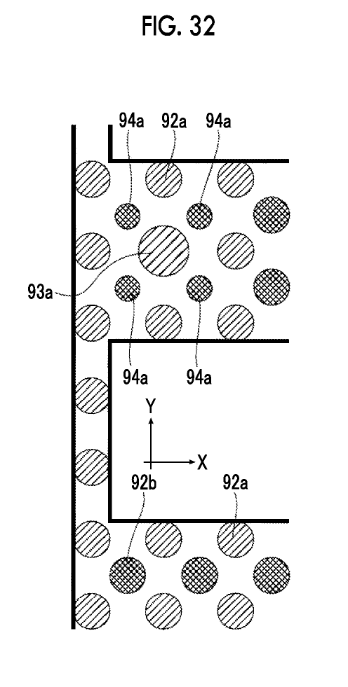

FIG. 31 is a schematic diagram showing a state in which first ink has been applied to a pattern, and FIG. 32 is a schematic diagram showing a state in which second ink has been applied to the pattern.

The same components of FIGS. 31 and 32 as the components of FIG. 28 are denoted by the same reference numerals as those of FIG. 28, and the detailed description thereof will be omitted.

After the ejection of the first ink droplets, the plate surface observation unit 26 images the surface of the plate and obtains plate surface-imaging data and the determination part 16d of the adjustment unit 16 performs determination. As a result, in a case in which a large dot 93a is formed as shown in FIG. 31 due to the malfunction of the ink jet head 40 or the like among the dots 92a formed by first ink droplets, the amount of ink to be ejected from the ink jet head 40 is changed by the control section 18 at the time of the second ejection of ink droplets. Accordingly, ink droplets are ejected at the time of the ejection of the next second ink droplets so that dots 94a having a small size are formed to surround the large dot 93a as shown in FIG. 32. Therefore, an appropriate pattern 90 can be formed.

The printing apparatus 10 is provided with the plate surface observation unit 26 and the determination part 16d, can image the surface 25a of the printing plate 25 to which ink has been applied and obtains plate surface-imaging data by the plate surface observation unit 26, and can determine whether or not the application of ink is appropriate by the determination part 16d of the adjustment unit 16. Since it is possible to perform a check, which corresponds to not a direct printing result but a printing result obtained from an actual substrate, by performing a method of applying ink at the next time or later, the restoration of the surface of a plate, and the like in accordance with the determination result of the determination part 16d of the adjustment unit 16, the reliability of a check is improved. Accordingly, printing accuracy can be improved. Moreover, the substrate 31 is also not wasted for printing confirmation. In addition, since complicated structures, such as check rollers, are not necessary, the cost of the apparatus can also be reduced.

Further, since doctoring is not necessary, the scumming of the surface 25a of the printing plate 25 caused by doctoring is prevented and the durability of the printing plate 25 can also be improved.

Next, a printing method of this embodiment will be described using the printing apparatus 10.

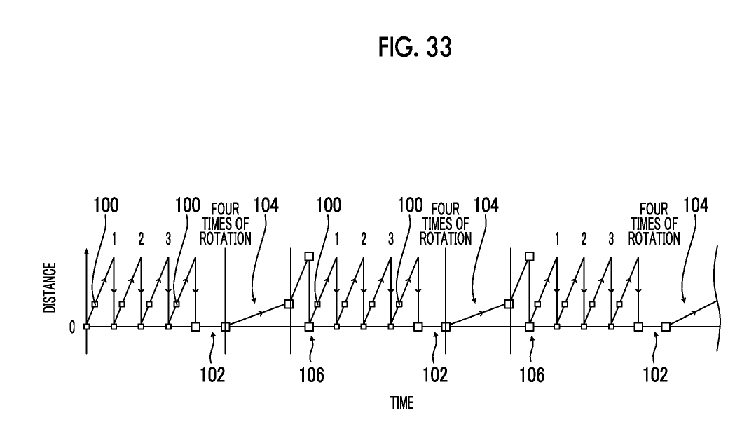

FIG. 33 is a schematic diagram illustrating a printing method of an embodiment of the invention.

As described above, the plate cylinder 24 is rotated multiple times and ink is applied to the pattern area at the time of each rotation. In FIG. 33, a distance represents the rotation angle of the plate cylinder 24 and a distance of 0 represents the initial position of the printing plate 25.

Further, in FIG. 33, reference numeral 100 denotes a timing at which ink is to be ejected, reference numeral 102 denotes an interval where ink is dried, and reference numeral 104 denotes an interval where ink is transferred to a substrate 31. Furthermore, reference numeral 106 denotes the starting position of the printing of the printing plate 25 in a case in which printing is performed multiple times.

In the printing apparatus 10, a specific pattern is printed on the substrate 31 on the basis of the pattern data of a pattern to be printed. The position information of the alignment marks A to D is acquired by the alignment camera 42, the mounting position information of the printing plate 25 is acquired, and the inclination of the printing plate 25 is obtained. In a case in which the inclination of the printing plate 25 is in the allowable range, a pattern is printed without the correction of inclination. In this case, when ink is applied to the pattern area, the scale 27 is read by the reading unit 47, the position information of the scale 27 is obtained, the ejection timing of ink to be ejected from the ink jet head 40 is adjusted, ink is ejected to the printing plate 25 in a predetermined ejection waveform, and inking is performed.

In a case in which the inclination of the printing plate 25 is out of the allowable range, inclination is corrected and a pattern is printed. When the inclination of the printing plate 25 is corrected in this way, printing accuracy can be improved even though the mounting accuracy of the printing plate 25 is low.

In the example shown in FIG. 33, the plate cylinder 24 is rotated four times and ink droplets are ejected at the time of each rotation. Whenever ink droplets are ejected, the plate surface observation unit 26 acquires information about the surface 25a of the printing plate 25, the determination part 16d of the adjustment unit 16 performs determination, and the control section 18 adjusts the amount of ink to be ejected and ink-ejection density on the basis of the determination result of the determination part 16d and ejects the next ink droplets. In this case, in a case in which there is a deficient portion in the recessed portion of the printing plate 25, the amount of ink to be ejected around the deficient portion is increased so that dots to be formed are increased in size. In addition, the number of ink droplets to be ejected is increased to be larger than a predetermined number so that ink droplet-ejection density is increased.

In contrast, in a case in which a large dot is formed in the recessed portion of the printing plate 25 when ink droplets are previously ejected, the amount of ink to be ejected is reduced so that dots to be formed are reduced in size. In addition, the number of ink droplets to be ejected is reduced to be smaller than a predetermined number so that ink droplet-ejection density is reduced.

Further, in a case in which the ink jet head 40 includes redundant nozzles, redundant nozzles can also be used.

For example, in the case of pattern data having 2400 dpi, the application of ink to a pattern area (inking) can be completed by four times of the scanning of a pattern having 1200 dpi in each of the X direction and the Y direction or four times of the scanning of a pattern having 600 dpi in the X direction and 2400 dpi in the Y direction.

Further, for example, in the case of a pattern having 1200 dpi in each of the X direction and the Y direction, a distance (minimum value) between adjacent pixels of one nozzle is also 21.2 μm and the request of an ejection frequency is low but the number of nozzles twice as large as the number of nozzles in the case of a pattern having 600 dpi in the X direction is necessary. Since a distance (minimum value) between adjacent pixels in the X direction is also 21.2 μm, there is a concern about the influence of landing interference in the X direction.

On the other hand, in the case of a pattern having 600 dpi in the X direction and 2400 dpi in the Y direction, the number of nozzles is a half of the number of nozzles in the case of the above-mentioned pattern having 1200 dpi in the X direction and a distance (minimum value) between adjacent pixels in the X direction is 42.3 μm. For this reason, the influence of landing interference in the X direction is reduced. However, since a distance (minimum value) between adjacent pixels in the Y direction is 10.6 μm, the influence of landing interference in the X direction is reduced and high-frequency wave ejection twice as high as high-frequency wave ejection in the case of the pattern having 1200 dpi in each of the X direction and the Y direction is necessary.

Next, the printing method of the printing apparatus 10 of this embodiment will be more specifically described.

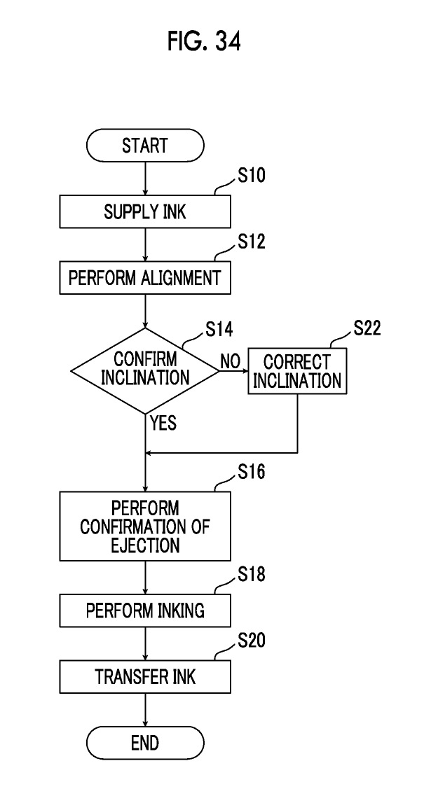

FIG. 34 is a flow chart illustrating the printing method of the embodiment of the invention.

First, ink is supplied to the ink tank (Step S10). In Step S10, ink is sent to the sub-tank from the ink tank first. Then, ink is supplied to the ink jet head 40 from the sub-tank.

When ink is supplied, a cleaning solution is substituted with ink. After the cleaning solution is discharged from the ink jet head 40 by nitrogen gas, ink can be supplied. However, nitrogen gas is likely to be entrained. For this reason, it is preferable that a cleaning solution is substituted with ink.

The confirmation of ejection is performed in a state in which a cleaning solution is supplied to the ink jet head 40. In a case in which the result of the confirmation of ejection is not good when the confirmation of ejection is performed, ejection recovery is performed using the maintenance section 36. In a case in which recovery cannot be performed, the ink jet head 40 is replaced as necessary.

When a cleaning solution is substituted with ink, a cleaning solution of, for example, the sub-tank 50 is reduced to a lower limit. After that, ink is supplied to the sub-tank 50 and the cleaning solution, which is present in the ink jet head 40, is made to flow to the outside by ink. Then, the ink of the sub-tank 50 is reduced to a lower limit. Making the cleaning solution, which is present in the ink jet head 40, flow to the outside by ink and reducing the ink of the sub-tank 50 to a lower limit are repeatedly performed to substitute the cleaning solution with ink.

Next, alignment is performed (Step S12).

In this case, the position of the ink jet head 40 and the position of the plate are aligned with each other. First, the alignment marks A to C are read by the alignment camera 42 and the positions of the alignment marks A to C are detected.

After that, an absolute distance in the X direction is obtained. In this case, the absolute distance is calculated from the position of the carriage 46 (the reading of a linear scale), for example, when the alignment marks A and B are positioned at the same position in the X direction of the field of view of the alignment camera 42.

Next, an absolute distance in the Y direction is obtained. In this case, the absolute distance is calculated from the rotational position information of the plate cylinder 24 that is output from the rotary encoder when the alignment marks A and C are positioned at the same position in the Y direction of the field of view of the alignment camera 42. In regard to the Y direction, the alignment of not a distance but an angle is adjusted.

After that, the inclination of the printing plate 25 relative to the ink jet head 40 is obtained. In this case, an inclination angle θ is obtained. Not only the positions of the alignment marks A and B in the X direction but also deviations in the Y direction are measured. Deviations in the Y direction are calculated from the rotational position information of the plate cylinder 24 that is output from the rotary encoder when the alignment marks are positioned at the same position in the Y direction of the field of view of the alignment camera 42, and the inclination angle θ is calculated from the distance in the X direction and the deviations in the Y direction. Alternatively, the inclination angle θ can also be calculated from deviations in the Y direction in the field of view of the camera.

Further, the mounting position information of the printing plate 25 on the plate cylinder 24 is obtained from the position information of the alignment marks A to C. That is, information about how the printing plate 25 is mounted on the plate cylinder 24 is obtained. Then, the inclination angle α of the printing plate 25 is obtained. For example, the angle α can be calculated from a distance in the X direction and a deviation in the Y direction.

The distance in the X direction, the angle in the Y direction, and the inclination angle θ, which are obtained as described above, are stored in the storage section 14. The control section 18 corrects pattern data by performing expansion/contraction processing in the X direction and the Y direction and the rotation processing of pattern data, which is based on the inclination angle θ, about the distance in the X direction, the angle in the Y direction, the inclination angle θ, and pattern data that is stored in the storage section 14 and is to be printed. The inclination correction of the printing plate 25 is performed on the corrected pattern data as necessary. Further, the adjustment of a timing at which ink is to be ejected from the ink jet head 40 is also performed by the control section 18.

Next, the inclination of the printing plate 25 is confirmed (Step S14).

The inclination angle α of the printing plate 25, which is obtained in Step S12, is compared with the allowable range, and processing proceeds to an ejection confirmation step (Step S16), which is the next step, if the inclination angle α is in the allowable range.

On the other hand, if the inclination angle α is out of the allowable range in Step S14, the inclination of the printing plate 25 is corrected (Step S22).

In Step S22, corrected pattern data is created as described above, the ejection timing of ink is adjusted, or the ink jet head 40 is rotated so as to correspond to the angle α on the basis of the angle α of the printing plate 25 so that the inclination of the printing plate 25 is corrected.

Next, the confirmation of ejection of the ink jet head 40 is performed (Step S16).

In this case, the confirmation of ejection is performed by the evaluation of a printed matter of a test pattern or the observation of ejection.

A printed matter of a test pattern is evaluated through the visual observation of a substrate, which has been subjected to printing, or the evaluation of a scanner. Further, it is also possible to perform the confirmation of ejection of the ink jet head 40 by only ejecting ink to the printing plate 25 without transferring the ink and observing the ink present on the printing plate 25 with the alignment camera 42.

The printing plate 25 is provided with the ejection confirmation area T as described above, and ink droplets are ejected to the ejection confirmation area T. The plate cylinder 24 may be provided with the ejection confirmation area T, and ink droplets may be ejected to the ejection confirmation area T.

After being evaluated, the ink of the ejection confirmation area T is removed by the cleaning unit 34 or is removed by being transferred to the substrate 31.

In a case in which the result of the confirmation of ejection deviates from a predetermined range, the maintenance section 36 performs a recovery operation or the ejection control unit 43 optimizes an ejection waveform.

Information about the landing positions of ink droplets ejected to the printing plate 25 is acquired using the alignment camera 42 together with the confirmation of ejection. The adjustment unit 16 determines a deviation in a landing position, and adjusts the expansion/contraction, rotation, and the like of the corrected pattern data again in a case in which the landing position deviates from predetermined ranges with respect to the X direction, the Y direction, and the inclination angle θ.

Next, inking to the printing plate is performed (Step S18).

The pattern data or the corrected pattern data is sent to the ejection control unit 43; the plate cylinder 24 is rotated; the scale 27 is read by the reading unit 47 at the time of the rotation of the plate cylinder 24; and the position information of the scale 27 is obtained (acquisition step). Then, the ejection timing of ink to be ejected from the ink jet head 40 is adjusted (adjustment step), ink is ejected to the printing plate 25 in a predetermined ejection waveform, and inking is performed. For example, the plate cylinder 24 is rotated four times, that is, the plate cylinder 24 is scanned four times, and ink is applied to the pattern area. In this case, spit is performed at the time of each scanning Spit is performed in the spit areas G of the printing plate 25 or a spit area (not shown) for spit that is provided on the plate cylinder 24.

Spit may be performed after a pattern is formed in a printing area, and may be performed for each printing plate. Purge, wipe, and spit may be performed per a certain number of printing plates, such as 100 printing plates, by the maintenance section 36, and the confirmation of ejection may be further performed.

Step S18 of performing inking corresponds to the acquisition step and the adjustment step.

Next, the printing plate 25, which has been subjected to inking, is transferred to a substrate 31 (Step S20).

First, a substrate 31 is placed on the stage 30 and the stage 30 stands by at the starting position Ps. Then, the alignment of the substrate 31 is performed to position the pattern of the printing plate 25.

Next, the stage 30 is moved in the transport direction V to dispose the substrate 31 at the printing position Pp below the plate cylinder 24. Then, the plate cylinder 24 is rotated and the printing plate 25 and the surface 31a of the substrate 31 come into contact with each other, so that the ink of the printing plate 25 is transferred to the substrate 31. After transfer, the stage 30 is moved in the transport direction V to move the printing plate 25 to move the printing plate 25 to the end position Pe from the printing position Pp below the plate cylinder 24. After that, the printing plate 25 on which a pattern is formed is moved from the stage 30 and is taken out to the outside of the casing 20.

The invention is basically adapted as described above. The printing apparatus and the printing method of the invention have been described above. However, the invention is not limited to the embodiments and it goes without saying that the invention may have various changes modifications without departing from the scope of the invention.

### EXPLANATION OF REFERENCES

10: printing apparatus
12: printing apparatus body
14: storage section
16: adjustment unit
18: control section
20: casing
22: image recording section
24: plate cylinder
25: printing plate
26: plate surface observation unit
30: stage
31: substrate
32: drying unit
34: cleaning unit
36: maintenance section
40: ink jet head
42: alignment camera
43: ejection control unit
44: laser displacement meter
46: carriage
47: reading unit
48: linear motor
49: rotating unit
50, 58: sub-tank
76: ejection observation unit
78: nozzle observation unit
A to D: alignment mark
G: spit area
T: ejection confirmation area
G₁₁, G₁₂, G₂₁, G₂₂, G₃₁, G₃₂: printing area

What is claimed is:

1. A printing apparatus that applies ink to a surface of a printing plate in the shape of a predetermined pattern and then transfers the ink applied in the shape of the pattern to a substrate, a scale being formed on the surface of the printing plate, the apparatus comprising:
a plate cylinder on which the printing plate is provided;
an image recording section that applies the ink to the surface of the printing plate in the shape of the predetermined pattern by an ink jet method;
a reading unit that reads the scale and obtains position information data of the scale;
a signal generation part that generates a signal based on the position information data obtained by the reading unit; and
an adjustment part that adjusts an ejection timing of the ink in the image recording section on the basis of the signal obtained by the signal generation part.

2. The printing apparatus according to claim 1,
wherein the scale is formed of recessed portions and protruding portions formed on the surface of the printing plate, and
the ink is applied to the recessed portions or the protruding portions by the image recording section.

3. The printing apparatus according to claim 1,
wherein the image recording section includes an ink jet head that ejects the ink to the surface of the printing plate, and a carriage that supports the ink jet head and moves the ink jet head in a direction parallel to a rotating shaft of the plate cylinder, and
the reading unit is provided on the carriage.

4. The printing apparatus according to claim 1, further comprising:
a mounting-position-information acquisition unit that acquires mounting information of the printing plate provided on the plate cylinder; and
a correction part that corrects ejection pattern data of the ink ejected to the surface of the printing plate and creates corrected pattern data on the basis of the mounting information of the printing plate obtained by the mounting-position-information acquisition unit,
wherein the image recording section applies the ink to the surface of the printing plate on the basis of the corrected pattern data.

5. The printing apparatus according to claim 3, further comprising:
a mounting-position-information acquisition unit that acquires mounting information of the printing plate provided on the plate cylinder; and
a rotating unit that rotates the ink jet head on the basis of the mounting information of the printing plate obtained by the mounting-position-information acquisition unit,
wherein the ink jet head is rotated by the rotating unit and is moved in a direction parallel to the rotating shaft by the carriage on the basis of the mounting information of the printing plate.

6. The printing apparatus according to claim 1,
wherein the printing plate is an intaglio plate, and the ink is applied to the recessed portions formed in the shape of the predetermined pattern by the image recording section.

7. A printing method that applies ink to a surface of a printing plate provided on a plate cylinder in the shape of a predetermined pattern and then transfers the ink applied in the shape of the pattern to a substrate, a scale being formed on the surface of the printing plate, the method comprising:
an acquisition step of reading the scale and obtaining position information data of the scale;
an adjustment step of generating a signal based on the position information data and adjusting an ejection timing of the ink, which is obtained when the ink is applied in the shape of the predetermined pattern by an ink jet method, on the basis of the signal; and
an application step of applying ink to the surface of the printing plate at the ejection timing that is adjusted by the adjustment step.

8. The printing method according to claim 7,
wherein the adjustment step comprises:
a step of acquiring mounting information of the printing plate provided on the plate cylinder; and
a step of correcting ejection pattern data of the ink ejected to the surface of the printing plate and creating corrected pattern data on the basis of the mounting information of the printing plate, and
the application step comprises a step of applying the ink to the surface of the printing plate on the basis of the corrected pattern data.

9. The printing method according to claim 7,
wherein the adjustment step comprises:
a step of acquiring the mounting information of the printing plate provided on the plate cylinder; and
a step of rotating the ink jet head and moving the ink jet head in a direction perpendicular to a feed direction of the printing plate on the basis of the mounting information of the printing plate.

10. The printing apparatus according to claim 2,
wherein the image recording section includes an ink jet head that ejects the ink to the surface of the printing plate, and a carriage that supports the ink jet head and moves the ink jet head in a direction parallel to a rotating shaft of the plate cylinder, and
the reading unit is provided on the carriage.

11. The printing apparatus according to claim 2, further comprising:
a mounting-position-information acquisition unit that acquires mounting information of the printing plate provided on the plate cylinder; and
a correction part that corrects ejection pattern data of the ink ejected to the surface of the printing plate and creates corrected pattern data on the basis of the mounting information of the printing plate obtained by the mounting-position-information acquisition unit,
wherein the image recording section applies the ink to the surface of the printing plate on the basis of the corrected pattern data.

12. The printing apparatus according to claim 3, further comprising:
a mounting-position-information acquisition unit that acquires mounting information of the printing plate provided on the plate cylinder; and
a correction part that corrects ejection pattern data of the ink ejected to the surface of the printing plate and creates corrected pattern data on the basis of the mounting information of the printing plate obtained by the mounting-position-information acquisition unit,
wherein the image recording section applies the ink to the surface of the printing plate on the basis of the corrected pattern data.

13. The printing apparatus according to claim 10, further comprising:
a mounting-position-information acquisition unit that acquires mounting information of the printing plate provided on the plate cylinder; and
a rotating unit that rotates the ink jet head on the basis of the mounting information of the printing plate obtained by the mounting-position-information acquisition unit,
wherein the ink jet head is rotated by the rotating unit and is moved in a direction parallel to the rotating shaft by the carriage on the basis of the mounting information of the printing plate.

14. The printing apparatus according to claim 2,
wherein the printing plate is an intaglio plate, and the ink is applied to the recessed portions formed in the shape of the predetermined pattern by the image recording section.

15. The printing apparatus according to claim 3,
wherein the printing plate is an intaglio plate, and the ink is applied to the recessed portions formed in the shape of the predetermined pattern by the image recording section.

16. The printing apparatus according to claim 4,
wherein the printing plate is an intaglio plate, and the ink is applied to the recessed portions formed in the shape of the predetermined pattern by the image recording section.

17. The printing apparatus according to claim 5,
wherein the printing plate is an intaglio plate, and the ink is applied to the recessed portions formed in the shape of the predetermined pattern by the image recording section.
